(19) United States
(12) Patent Application Publication
(10) Pub. No.: US 2012/0109665 A1
(43) Pub. Date: May 3, 2012

(54) DYNAMIC ORDER IDENTIFICATION CODES

(76) Inventors: Erik L. Knutson, Kirkland, WA (US); Christina R. Knutson, Kirkland, WA (US)

(21) Appl. No.: 12/968,428

(22) Filed: Dec. 15, 2010

Related U.S. Application Data
(60) Provisional application No. 61/408,983, filed on Nov. 1, 2010.

(51) Int. Cl. G06Q 30/00; G06Q 10/00

(52) U.S. Cl. 705/1.1

(57) ABSTRACT

The subject disclosure relates devices, systems and methodologies that employ dynamically determined reusable unique order identification codes or numeric identifiers to improve service-based transaction efficiency and customer satisfaction. In one aspect, reusable unique order identification codes or numeric identifiers can be dynamically determined at or near the time of a transaction or a prospective transaction, based in part on one or more independently specifiable order attributes as selected by a user. As a further advantage, embodiments of the disclosed subject matter can improve customer loyalty and provide a competitive edge in attracting customers. Further non-limiting embodiments are provided that illustrate the advantages and flexibility of the disclosed subject matter.

### CROSS-REFERENCE TO RELATED APPLICATIONS

This application claims priority to U.S. Provisional Patent Application Ser. No. 61/408,983, filed on Nov. 1, 2010, and entitled DYNAMIC ORDER IDENTIFICATION CODES, the entirety of which is hereby incorporated by reference.

### FIELD OF THE INVENTION

The subject disclosure is directed to identification codes and, more specifically, relates to dynamic order identification codes.

### BACKGROUND OF THE INVENTION

Modern life is rife with consumer frustration as a result of failures in service-based transactions. That an entire genre of jokes has developed describing the frustration and disappointment is no surprise, given the fact that even a simple and possibly excusable lapse in concentration by a party to a transaction can engender such levels of consumer disappointment, frustration, and ill will, and can result in unreasonable delays, inefficiency, loss of productivity, lost customer good will, and negative publicity. For instance, in the consumer world, when inaccurate orders are received, placed, and/or communicated, the potential for waste in terms of time and money is apparent. For example, as a result of a simple failure in service-based transactions, a customer is forced to face the unenviable choice of either deciding to return to an establishment or point of sale (POS) to exchange or return the product and/or provide a receipt or proof of purchase to be allowed to return the item, or deciding to live with the discrepancy and the attendant dissatisfaction, frustration, and ill will toward the proprietor of the establishment.

As a further example, in many service-based transactions, it is simply infeasible or not financially rational for customers to return or exchange a product. For example, due to relative price levels, opportunity costs, available future substitutes, customer indifference, and any number of other factors, customers may simply accept a product or service as-is, despite feelings of extreme dissatisfaction with the company or individual the customer transacted with not getting the original order correct. While a singular or insubstantial employee error may be understandable and forgivable, at some point, a customer having to repeatedly return products as a result of employee error will simply refuse further opportunities to transact with the company or business. It is only rational that the customer must factor into the cost of the product or service the risk of future wasted valuable time and resources that would be required in the event of future of failures in service-based transactions. In even more critical service-based transactions, the failures can result in added costs or losses to the customer, for example, in the case of time-sensitive order, the failure of which has the possibility of resulting in delays for delivering the customers products according to its commitments.

As a further example, it can be understood that as a result of service-based transactions failures in large companies, excessive and potentially unnecessary amounts of financial resources are tied up in the companies' return departments. For instance, otherwise avoidable losses can arise from shipping and handling costs to additional employee expenses that can be required as a cost of counseling disappointed customers to minimize the loss of good will. These potential costs are in addition to any inventory loss that may become necessary in an effort to assuage dissatisfied customers. Some of the inventory loss is a result of an employee who incorrectly filled an order.

Thus, while various systems such as stock-keeping units (SKUs), price look-up (PLU) numbers, Universal Product Codes (UPCs) and the like have been used to increase efficiencies in inventory management, tracking, and transacting business at a POS, these systems are not without drawbacks. For instance, these systems can all be characterized in that they are supply side specified for the convenience of the suppliers, retailers, and other entities on a sale side of a transaction (versus on the purchasing side of a transaction). As an example, customers cannot vary the items available in the inventory, cannot affect the codes associated with the items, or otherwise cannot specify items according to a granularity that drills down to that individual's desired item characteristics as opposed to item characteristics suitable for vast segments of a population (e.g., shirts are sold as XS, S, M, L, XL, XXL, etc. assuming that 6-7 categories cover all individuals).

In a further example, SKUs are often assigned and serialized at the merchant level, independent in some respects of customer demand. Thus, each SKU is attached to an item, variant, product line, bundle, service, fee, or attachment as determined by the merchant or supplier, without consideration of individual customer demand or preferences. Accordingly, while SKUs can be used to refer to different versions of the same product, it is clear that these attributes are not specifiable by a customer in any sense of the, until after the product versions are made available, and then only in the sense of the limited number of merchant supplied choices. In other instances, the systems may be determined on a more global level (e.g., UPCs, etc.) and even more removed from the customer transaction process.

Moreover, these systems are not capable of addressing the aforementioned problems identified in service-based transactions. For instance, systems using SKUs, for example, are typically employed in transactions that are more aptly termed product-based transactions. That is, in a transaction involving a customer purchasing groceries from a grocery store, any service received while in the establishment would typically be incident to the purchase of products. In other words, a customer has predetermined which product he or she is looking to purchase, and failing to locate it might ask the proprietor or an employee for assistance locating it. Any frustration that might arise from such a transaction might be caused by lack of inventory or general lack of availability. Thus, in this sense, the transaction is product-based, any SKU or other system is irrelevant to the product the customer desires, and as such the SKU or other system is irrelevant to any customer frustration that may result.

In contrast, in a typical service-based transaction, a proprietor or employee can be integral to the transaction in that the customer desires a product or service to his or her specification and relies on the proprietor or employee to accurately account for the customer's specification in the order fulfillment process. That is, the service received from the proprietor or employee can be central to the success or failure of the transaction. As such, the transaction can be viewed as a service-based transaction, where accurately accounting for the customer's specification in the order fulfillment process is key to a successful transaction (e.g., where all parties to the transaction are satisfied, etc.). Thus, when viewed in this light, it is clear that SKUs, PLUs, UPCs, and the like cannot address the problems associated with service based transactions.

While in many instances, customer-specified items such as food or beverages cannot be reused and are thrown out if made incorrectly, it is clear that as the number of attributes of a product that can be specified by, selected by, or received from a customer increases, the likelihood of the service-based transactions failures increases. It is thus desired to provide systems, devices, and methodologies that address these and other deficiencies as further described below.

### SUMMARY OF THE INVENTION

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

As used herein, the term “unique” is to be understood and appreciated with respect to a relevant scope of application. For instance, in a global scope of application for an identification code or a numeric identifier to be unique in the conventional sense, it would imply that there are no others like it. In other words, a database lookup using a globally unique identification code or numeric identifier would return only one unambiguous result no matter how large the database. Recognizing practical limitations, it is more likely that a reduced scope of application would be implemented. For example, an order system as described herein might be, given various considerations, appropriately scoped for a merchant or company on a geographical basis (e.g., coffee houses in Seattle, or western Washington, etc.) or other factor, rather than on an otherwise arbitrary scope. Thus, having a unique or locally unique identification code or numeric identifier would imply that, a database lookup using a locally unique identification code or numeric identifier would return only one unambiguous result within the database applicable to a reduced scope of application. It is recognized, of course, outside of the scope of the intended application a locally unique identification code or numeric identifier could be non-unique in the conventional sense.

As further used herein the term “reusable” as applied to a unique order identification code or a numeric identifier is intended to refer to the prospect of continued ability to reuse (e.g., continued ability to reference the unique order identification code or a numeric identifier) to conduct a transaction for the same item (e.g., product, service, combinations of products, combinations of services, combinations of products and services, etc.) time after time. In addition the terms “dynamic” or “dynamically,” such as in the phrase “dynamically determined or generated reusable unique order identification codes or numeric identifiers” is intended to denote that the order identification codes or numeric identifiers can be determined or generated at or near the time of a transaction (e.g., an actual transaction, a prior transaction, a current transaction, a prospective transaction, etc.).

In addition, the term “numeric” as used in the phrase “numeric identifier” is intended to encompass numeric and alphanumeric identifiers as well as symbolic identifiers.

Moreover, the use of the term “independently” in the phrase “independently specifiable order attributes” is intended to convey the notion that one of a “specifiable order attribute” does not depend on the existence or presence of another “specifiable order attribute” in the order's specification of a plurality of “independently specifiable order attributes.” For example, if a hamburger is the item that is the object of an order, an order attribute “sesame seed bun” could be considered independent of an order attribute “cheese.” However, depending on the context, variations could be presented in which a seemingly “independently specifiable order attribute” is not completely independent, for example, via restrictions on available options. In addition, it can be understood that the term “specifiable” in the phrase “specifiable order attribute” is intended to mean that the attribute is within the realm of sensible or available attributes that can be specified, selected by, or received from a user about an item. For example, an attribute “17 inch wheels” for an order item “hamburger” is nonsensical and would lie outside the realm of “specifiable order attributes.” Similarly, depending on the context, seemingly viable attributes (e.g., those that are not nonsensical, etc.) can lie outside the realm of “specifiable order attributes,” for example, via restrictions on available options according to a predetermined item option set.

In various embodiments, the disclosed subject matter relates to identification codes and, more specifically, relates to dynamic order identification codes. For instance, to the foregoing and related ends, systems, devices, and methodologies are disclosed that can help to remove some of the guess work and remove or prevent many of the factors which lead to human error in the execution of serviced-based transactions. Exemplary embodiments of the disclosed subject matter can provide a way to identify and code products as demanded by consumers in a unique way, which identification and coding is designed with the customer in mind.

According to various non-limiting embodiments, the disclosed subject matter can provide a code (e.g., an order identification code, a unique order identification code or numerical identifier, etc.) that the customer or other user (e.g., employee, staff, owner, proprietor, contractor, etc.) can use to request an exact item (e.g., product, service, combinations of products, combinations of services, combinations of products and services, etc.), including all of its detailed options or independently specifiable order attributes as desired by the customer (e.g., as specified by, selected by, or received from a user, etc.). In particular non-limiting embodiments, code can be stored for subsequent use to order or reorder the desired item. Thus, the code can become a convenient tool that a customer can advantageously reorder the same item from a business (e.g., the same company, a different company, etc.) periodically, (e.g., month after month, week after week, day after day, etc.).

Accordingly, in non-limiting embodiments, exemplary systems can comprise an identification component adapted to dynamically generate one or more reusable unique order identification code(s) numeric identifier(s) for an order based in part on information comprising a plurality of independently specifiable order attributes, and a communications component adapted to transmit or receive the reusable unique order numeric identifier determined to facilitate at least one transaction associated with the order. Exemplary systems can further comprise an analysis component adapted to analyze the reusable unique order numeric identifier and determine one of the plurality of independently specifiable order attributes selected by the user. In a non-limiting aspect, reusable unique order identification code(s) numeric identifier(s) for an order can be dynamically generated based on an existing reusable unique order numeric identifier and a computed offset value.

In addition, exemplary methodologies can comprise generating one or more reusable unique order identification code(s) or numeric identifier(s) for an order based in part on a plurality of independently specifiable order attributes specified by, selected by, or received from a user, and transmitting or receiving the reusable unique order identification code to facilitate one or more transaction(s) associated with the order.

These and other features of the disclosed subject matter are described in more detail below.

### BRIEF DESCRIPTION OF THE DRAWINGS

The devices, components, systems, and methodologies of the disclosed subject matter are further described with reference to the accompanying drawings in which:

FIG. 1 depicts a block diagram illustrating an exemplary product label with a unique identification code and having tear portion on the bottom suitable for use with aspects of the disclosed subject matter;

FIG. 2 depicts a block diagram illustrating an exemplary product label with a unique identification code and having tear portion along the side suitable for use with aspects of the disclosed subject matter;

FIG. 3 illustrates an exemplary non-limiting flow diagram of methodologies for performing aspects of embodiments of the disclosed subject matter;

FIG. 4 illustrates a further non-limiting flow diagram of methodologies for performing aspects of embodiments of the disclosed subject matter;

FIG. 5 depicts an exemplary non-limiting process flow diagram illustrating various aspects of exemplary methodologies for determining or generating one or more reusable unique order identification code(s) or numeric identifier(s);

FIG. 6 illustrates an overview of an exemplary computing environment suitable for incorporation of embodiments of the disclosed subject matter;

FIG. 7 illustrates an exemplary non-limiting block diagram showing illustrative aspects of embodiments of the disclosed subject matter;

FIG. 8 illustrates an exemplary non-limiting block diagram of a system according to various embodiments of the disclosed subject matter;

FIG. 9 depicts a further non-limiting block diagram of a system according to further embodiments of the disclosed subject matter;

FIG. 10 illustrates an exemplary non-limiting device or system suitable for performing various aspects of the disclosed subject matter;

FIG. 11 illustrates an exemplary non-limiting device or system suitable for performing various aspects of the disclosed subject matter;

FIG. 12 illustrates an exemplary non-limiting device or system suitable for performing various aspects of the disclosed subject matter;

FIG. 13 is a block diagram representing exemplary non-limiting networked environments in which various embodiments described herein can be implemented; and

FIG. 14 is a block diagram representing an exemplary non-limiting computing system or operating environment in which one or more aspects of various embodiments described herein can be implemented.

### DETAILED DESCRIPTION OF ILLUSTRATIVE EMBODIMENTS

### Overview

As described above, losses associated with failed service-based transactions can be avoided if the customer had a way to explicitly specify a desired item or specific order and conveniently communicate such desires, for example, via a numeric code. For instance, a numeric code facilitate ensuring that the exact item (e.g., product, service, etc.) with the exact combination of independently specifiable order attributes the customer desired was placed each time the order was made. Accordingly, in non-limiting embodiments, the disclosed subject matter can provide a code (e.g., an order identification code, a unique order identification code, etc.) that the customer can use to request an exact item (e.g., product, service, combinations of products, combinations of services, combinations of products and services, etc.), including all of its detailed options or independently specifiable order attributes as desired by the customer and as specified by, selected by, or received from a user (e.g., customer, employee, staff, owner, proprietor, contractor, etc.).

In particular non-limiting embodiments, code can be stored for subsequent use to order or reorder the desired item. Thus, as described above, a code can become a convenient tool that a customer can advantageously reorder the same item from a business (e.g., the same company, a different company, etc.) periodically, (e.g., month after month, week after week, day after day, etc.). Accordingly, whereas bar code systems and the like are typically associated with other inventory management details (e.g., pricing, stock on hand, etc.) as is expected for tracking inventory of multiple numbers of identical products, various embodiments of the disclosed subject matter do not necessarily require information such as pricing and other inventory management details (but do not necessarily exclude the association of such details either) to facilitate ensuring that the service-based transaction proceeds successfully (e.g., the customer receives what he or she desires, etc.). It can be understood, that the disclosed subject matter can address the desires and wishes of customers to receive the exact item they were expecting, or the exact item they were expecting in a repeatable way.

As a result, exemplary embodiments of the disclosed subject matter can provide a strong competitive advantage. For instance, companies employing exemplary embodiments of the disclosed subject matter can benefit by improving the rate at which serviced-based transactions are fulfilled successfully, thereby increasing overall customer satisfaction and loyalty. Thus, it can be understood that exemplary embodiments of the disclosed subject matter can be used to effectively compete in a highly competitive markets or fields. As a further advantage, the disclosed subject matter can facilitate efficiency and productivity enhancements by bringing order to an otherwise unstructured or disordered customer relation and service-based transaction processes. Of course, according to various aspects, exemplary embodiments of the disclosed subject matter would be particularly useful to both companies and consumers alike.

In exemplary non-limiting implementations, the disclosed subject matter can provide one or more devices adapted transmit or receive a dynamically determined reusable unique order identification code or numeric identifier determined at least in part on information comprising a plurality of independently specifiable order attributes specified by, selected by, or received from a user (e.g., customer, employee, staff, owner, proprietor, contractor, etc.). Thus, in various aspects, exemplary embodiments of the disclosed subject matter can provide customers with a solution to order specific items via dynamically determined reusable unique order identification code or numeric identifiers. Accordingly, in exemplary embodiments of the disclosed subject matter, customers with complex repeat orders and those who want to simplify the process can employ the embodiments as described herein. As a result, order accuracy can be assured and the prospect that items desired are exactly the items received can be a virtual certainty making the transaction process more pleasant.

Accordingly, in further non-limiting aspects, exemplary embodiments of the disclosed subject matter can provide system(s) that can dynamically determine a reusable unique order identification code or numeric identifier to provide a unique number for each item. For instance, in non-limiting aspects, can comprise a dynamically determined reusable unique order identification code or numeric identifier can be determined based at least in part based on information comprising a plurality of independently specifiable order attributes specified by, selected by, or received from a user (e.g., customer, employee, staff, owner, proprietor, contractor, etc.). In addition, exemplary systems can be configured to transmit or receive the dynamically determined reusable unique order identification code or numeric identifier. It can be understood that various embodiments of the disclosed subject matter are flexible in that they can facilitate generating new unique order identification codes or numeric identifiers, as new items are added to a company's inventory, as new combinations of independently specifiable order attributes are specified by, selected by, or received from a customer, as different combinations of independently specifiable order attributes are received from a remote location, etc.

In yet other non-limiting embodiments, the disclosed subject matter provides methodologies for determining a reusable unique order identification code or numeric identifier based at least in part on a plurality of independently specifiable order attributes, for example, as specified by, selected by, or received from a user (e.g., customer, employee, staff, owner, proprietor, contractor, etc.), and transmitting or receiving the reusable unique order identification code or numeric identifier. Thus, it can be understood that the idea of creating a reusable unique order identification code or numeric identifier for items can be advantageous to the customer. For instance, as described, it can help streamline business processes, for example, where customers are required to provide data in order to facilitate meeting customer needs. As a further example, many industries can benefit from having an algorithm that facilitates determining or generating a reusable unique order identification code or numeric identifier for the customer to use at their discretion.

As the consumer world is constantly changing, and as more customers desire to create customized item orders (e.g., food orders, beverage orders, service orders, etc.) or to make repeated use of the customized item orders, order systems that employ a reusable unique order identification code or numeric identifier could benefit both consumers and companies that wish to compete by providing superior customer service. Accordingly, in various aspects of the disclosed subject matter, exemplary non-limiting implementations can help to prevent ordering errors that can lead to failures of service-based transactions, for example, in companies that desire to develop and retain a loyal customer base whose customers can be expected to make repeat purchases or item orders. Under these circumstances, with the use of various embodiments of the disclosed subject matter, many companies' overall customer interaction processes can help improve customer loyalty and satisfaction by facilitating giving the customer exactly what he or she wants, each and every time.

### Exemplary Implementation Scenarios

While a brief overview has been described above in order to provide a basic understanding of some aspects of the specification, various non-limiting implementation scenarios are now described as a further aid in understanding the advantages and benefits of various embodiments of the disclosed subject matter. To that end, it can be understood that such scenarios are merely provided as an illustration and not limitation.

For instance, order systems that can employ reusable unique order identification codes or numeric identifiers can allow for several different types of implementation. In one non-limiting example, a company can preload its entire inventory into the order system and determine or generate a reusable unique order identification code or numeric identifier for each of its items (e.g., products, services, etc.). In a further non-limiting example, a company can generate new reusable unique order identification codes or numeric identifiers as new items are created in the order system.

### Exemplary Scenarios: Scenario 1: Coffee Company

As an example, consider the business of a coffee house. In the event that the coffee house wants to create an item (e.g., an original signature drink or drink of the month), the order system can generate a new reusable unique order identification code or numeric identifier for the new drink. If the new item's set of attributes is close to another already existing item's attributes, and it is believed to be a rarity, for example, the new item be created in the order system as a previously existing reusable unique order identification code or numeric identifier plus an offset value (e.g., previously existing reusable unique order identification code or numeric identifier +1, etc.). As a further example, if a customer ordered an item such as small hot chocolate with caramel, the previously existing reusable unique order identification code or numeric identifier could a value such as #42, whereas if the customer ordered a small hot chocolate with caramel and salt, then the item with salt could be the reusable unique order identification code or numeric identifier for the small hot chocolate with caramel +1.

It can be understood that, over time, the order system could also learn based on customer requests. For instance, in the case of a complicated order, an algorithm could generate or determine a reusable unique order identification code or numeric identifier based in part on independently specifiable order attributes specified by, selected by, or received from a user (e.g., customer, employee, staff, owner, proprietor, contractor, etc.). In addition, once the reusable unique order identification code or numeric identifier determined or generated, it could be published across other affiliates (e.g., company wide, program wide, etc.). In this sense, an order system could update one or more additional business locations with the new reusable unique order identification code or numeric identifier for the new item and the associated independently specifiable order attributes specified by, selected by, or received from a user (e.g., customer, employee, staff, owner, proprietor, contractor, etc.). Therefore, if a similar item were requested, the independently specifiable order attributes specified by, selected by, or received from a user (e.g., customer, employee, staff, owner, proprietor, contractor, etc.) can have the same root or existing reusable unique order identification code or numeric identifier but with a different offset value (e.g., previously existing reusable unique order identification code or numeric identifier +2, etc.).

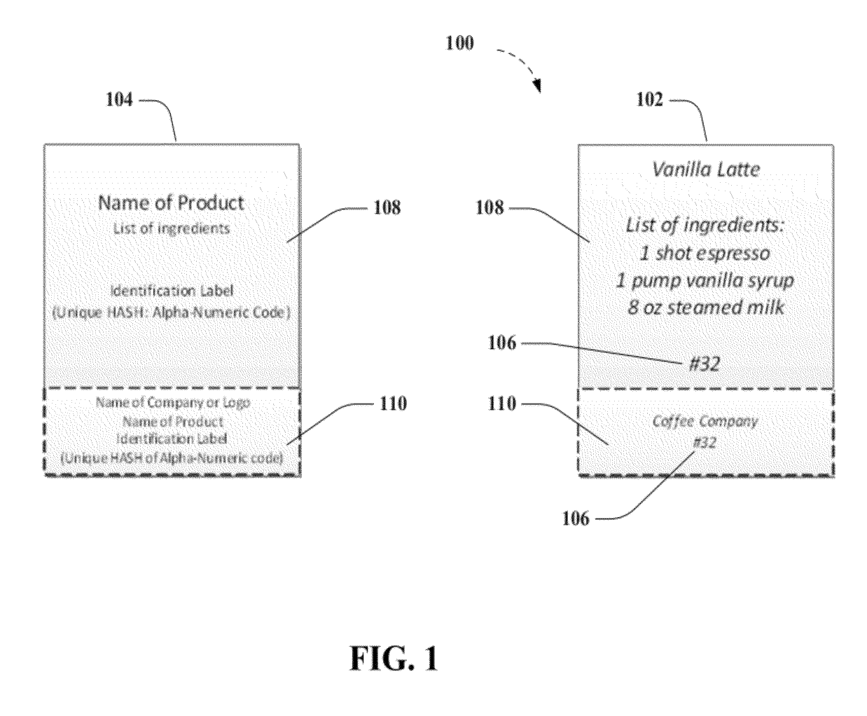

Thus, in an exemplary non-limiting implementation, a new customer can drive up to a coffee house drive through window and attempt to order a beverage. If the customer is new to this specific coffee house chain and is not sure what type of drink to order, the customer can ask numerous questions about the possible drink combinations and options (e.g., one or more independently specifiable order attributes, etc.). FIG. 1 depicts a block diagram 100 illustrating an exemplary product label 102 and components 104 thereof, for example, having a reusable unique order identification code or numeric identifier 106 on a first portion 108 and having tear portion 110 on the bottom suitable for use with aspects of the disclosed subject matter.

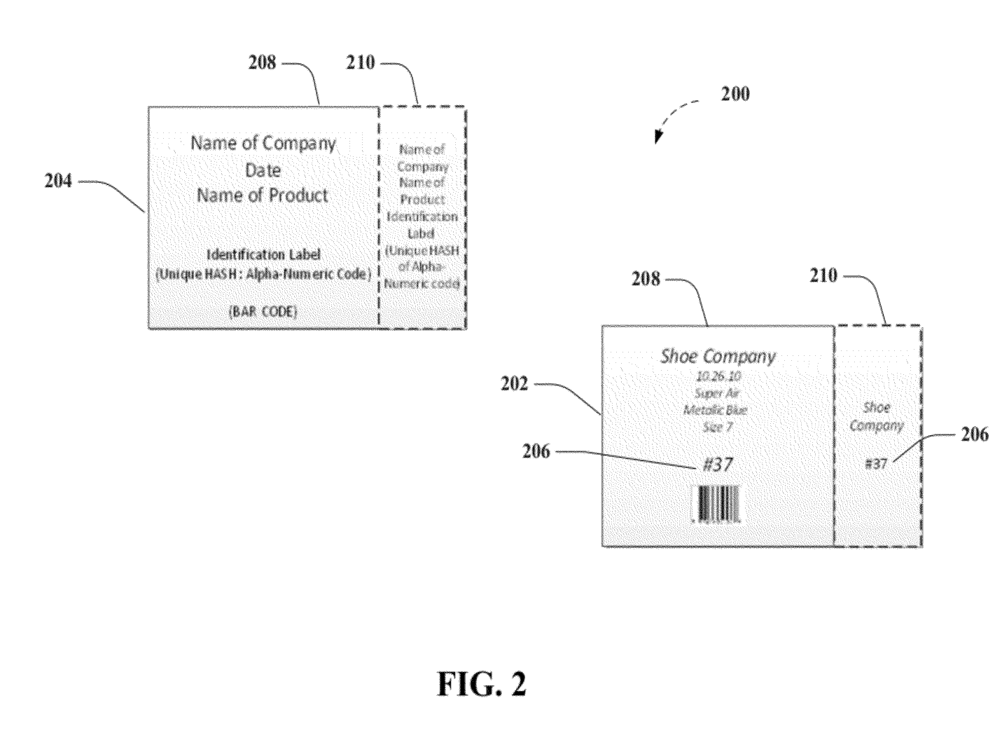

FIG. 2 depicts a block diagram 200 illustrating an exemplary product label 202 and components 204 thereof, for example, having a reusable unique order identification code or numeric identifier 206 on a first portion 208 and having tear portion 110 along the side suitable for use with aspects of the disclosed subject matter. It can be understood that exemplary product label 102 (202) can have an adhesive or another means for affixing the label 102 (202) to the order. For instance, and adhesive can be applied to the respective first portions 108 (208) to facilitate affixing the printed label to the order. Thus, in various aspects, embodiments of the disclosed subject matter can comprise a label or labeling systems or methodologies adapted to be applied to a product or a representation thereof (e.g., representations of products, service, etc.) using any of a variety of adhesion techniques and having any of a variety of indicia printed thereon including data representing an identification code. Accordingly, after the customer makes a request for a specific drink order, the customer can be given a drink with a product label that has a “tear portion” on the label as further described below regarding FIGS. 1-2. In the event that the customer enjoys the drink, he or she can tear off the label with the drink order number (e.g., the reusable unique order identification code or numeric identifier, etc.) and keep it for placing subsequent orders of the same drink.

Coincidentally, the drink order number (e.g., the reusable unique order identification code or numeric identifier, etc.) can be stored in the coffee house's order system, so that upon future visits in which the customer desires placing subsequent orders of the same drink, the order can be entered into the order system by referencing the drink order number (e.g., the reusable unique order identification code or numeric identifier, etc.). As can be understood, this illustrative implementation demonstrates the capacity for the various embodiments of the disclosed subject matter to save time for both the customer and the coffee company employees. As an example, the customer does not have to remember the drink details but can simply say I would like a #29 drink (e.g., the drink order number, the reusable unique order identification code or numeric identifier, etc.). In addition, order accuracy can be improved as the employee can type in the code #29 and will get the exact specification for the desired drink order. The employee can read the exact drink requirements on a display screen as if it were a recipe to follow, thus cutting down on mistakes, miscommunications, while increasing productivity for both the employee and the customer.

Note that while order systems have employed numbers to represent an order item menu or an order item specification, it can be understood that, such numbers have not been dynamically determined reusable unique order identification code or numeric identifier, as described above. For instance, these systems can all be characterized in that they are supply side specified for the convenience of the suppliers, retailers, and other entities on a sale side of a transaction (versus on the purchasing side of a transaction). In addition, these numbers are not dynamically determined. Rather, they are created ahead of the prospective transaction dates. Moreover, these numbers are not created on the basis of one or more independently specifiable order attributes. In contrast, the order attributes are determined in advance to include certain items, aspects, or characteristics, that are not specifiable (e.g., able to request changes or alterations) without changing to a different fixed order number.

In another exemplary implementation, a loyal customer can drive up to a coffee house drive through window and order his or her desired drink. If the drink item order is complicated, requiring the employee to pay extra special attention to the drink order to get it exactly the way the customer would like it, it can be understood that as the number of attributes of a product (e.g., the drink) that can be specified by, selected by, or received from the customer increases, the likelihood of failure of this service-based transaction increases. For example, the employee can forget to add an extra pump of syrup, to double-cup the hot beverage, add extra ice, and so on. As a result of such failures, the loyal customer can become frustrated that he or she cannot get the specific drink item order exactly the way it was ordered without the hassle each day of asking and again re-asking the employee for the specific drink preferences. Thus, it is clear that by placing an order via a dynamically determined reusable unique order identification code or numeric identifier (e.g., one that is generated or determined on the basis of the one or more independently specifiable order attributes), in addition to preventing customer frustration, the order system can save both the customer and the employee time. For example, the employee need only reference the customer's dynamically determined reusable unique order identification code or numeric identifier to determine that the customer's order item is a Grande mocha with soy milk and an extra shot of espresso, two pumps of caramel syrup, two pumps of chocolate syrup, and double cupped, etc.

Further variations on this scenario can be envisioned upon review of the disclosed subject matter. For instance, an employee going on a coffee run for an office can receive his or her office mates' drink order number(s) (e.g., the reusable unique order identification code or numeric identifier, etc.) for example, via the aforementioned label tear portions, via an electronic device (e.g., cell phone, mp3 player, laptop, email device, network capable device, camera, tablet personal computer, etc.), and so on. Rather than the runner and his or office mates having to spend the time collecting coffee orders, the runner can simply receive and then subsequently relay the set of drink order number(s) (e.g., one or more reusable unique order identification code or numeric identifier, etc.) without equivocation, misunderstanding, loss of information in communication, order collection, or placement and so on. Thus, in addition to improving productivity for the coffee house employees, the office can benefit indirectly as well.

### Scenario 2: Retail Company

In yet another exemplary implementation relating to a retail establishment, a customer desiring his or her favorite pair of running shoes, can be faced with a retail attendant who is not sure which brand, version, size, color, etc. (e.g., any of the one or more independently specifiable order attributes, etc.) of shoes the customer desires. In this instance, the customer can simply refer to a dynamically determined reusable unique order identification code or numeric identifier (e.g., “the #37” or “the #28”). By referencing the customer's dynamically determined reusable unique order identification code or numeric identifier, the attendant can immediately know the brand, version, size, color, make, and model (e.g., any of the one or more independently specifiable order attributes, etc. that form a basis for the customer's dynamically determined reusable unique order identification code or numeric identifier) of the shoes the customer desires. For example the #37 could be a size seven of a particular brand running shoe in metallic silver. The customer's dynamically determined reusable unique order identification code or numeric identifier can also include additional information (e.g., any of additional independently specifiable order attributes, etc.) such as, for example, a preference or requirement for shoes with lifts, proper arch support for people with bad backs, auto-corrective features such as specific padding features for people who pronate or supinate while running, etc.

### Scenario 3: Services Company

In further non-limiting implementations relating to a services company (e.g., a car dealership, etc.), a customer may want to log on to a car dealership's website to request a car for their vacation. By employing a dynamically determined reusable unique order identification code or numeric identifier to find the perfect car the customer wishes to rent every time (e.g., with his or her set of one or more independently specifiable order attributes, etc.) the customer can avoid going through the hassle of remembering all the details such as the make, model, year, number of doors, air conditioning or no air conditioning, convertible, Luxury, SUV, Minivan, and so on (e.g., the one or more independently specifiable order attributes, etc.). Thus, it can be understood that by using the customer's dynamically determined reusable unique order identification code or numeric identifier, the order system can take the hassle out of the paperwork, long lines, and the decision making process for repeat or loyal customers, for example.

### Other Exemplary Scenarios

In still further non-limiting implementations relating to a car purchase experience, for instance, a customer can desiring to purchase a new car from a automobile manufacturer's website (e.g., Porsche™ website, etc.). For example, suppose the customer wishes to purchase Porsche™ Twin Turbo 911™ (997) with several features (e.g., the one or more independently specifiable order attributes, etc.). The customer can search for specific criteria resulting in a list of cars with customizable options, or the customer can customize a virtual vehicle based on the several features. As a further example, the customer can then determine to buy a car with the one or more independently specifiable order attributes (e.g., park assist, custom metallic color, and upgraded rims, sound system, and painted interior extras, etc.) such as one of the cars with the customizable options, the customized virtual vehicle, etc. In addition, website can display additional lists of additions that the customer can pick and choose from. Once the customer has selected all of the options that he or she cares about (e.g., the one or more independently specifiable order attributes, etc.), the customer can request that specific item or product number (e.g., the dynamically determined reusable unique order identification code or numeric identifier based in part on the one or more independently specifiable order attributes).

As a result, the customer can then search using his or her dynamically determined reusable unique order identification code or numeric identifier to determine the availability (e.g., how many local dealerships carry the car, etc.) according to the one or more independently specifiable order attributes. In an alternative implementation, the customer can order it directly from the manufacturing company, determine an expected delivery date, etc. In a further alternative implementation, an order system can respond to the customer's query on the dynamically determined reusable unique order identification code or numeric identifier with partial solutions or suggestions that include identifying one or more exceptions or additions to the customers list of independently specifiable order attributes. For instance, the customer's local dealership may have 2 Porsche™ Twin Turbo 911's™ that include all of the customer's criteria with some additions (e.g., such as one car may include leather seats while the other includes heated seats, etc.). Accordingly, in various embodiments of the disclosed subject matter, the customer can be allowed determine which car he or she wanted based on the additional information, the exceptions, etc.

Thus, it can be understood that in various non-limiting aspects, embodiments of the disclosed subject matter can facilitate determining or generating one or more reusable unique order identification code(s) or numeric identifier(s) via an algorithm (e.g., a first reusable unique order identification code or numeric identifier). For instance, various algorithms can determine or generate one or more reusable unique order identification code(s) or numeric identifier(s) for items available for purchase (e.g., product-specific items, etc.) in a company's inventory list or catalog. The one or more reusable unique order identification code(s) or numeric identifier(s) can be randomly generated and assigned, or the company can put in specific assignment criteria for specific items.

In any event, upon a customer placing an order for an item that additionally specifies a desired one or more additional independently specifiable order attributes, an order system can determine or generate a reusable unique order identification code or numeric identifier (e.g., a second reusable unique order identification code or numeric identifier) based part on the e.g., a first reusable unique order identification code or numeric identifier and an offset value. In a further non-limiting example, the first reusable unique order identification code or numeric identifier as described above can also be dynamically determined at the time the customer specifies the one or more independently specifiable order attributes (e.g., without a predetermined reusable unique order identification code or numeric identifier and offset construct) as specified by, selected by, or received from a user (e.g., customer, employee, staff, owner, proprietor, contractor, etc.).

In further non-limiting aspects of the disclosed subject matter, various non-limiting embodiments can facilitate assigning the one or more reusable unique order identification code(s) or numeric identifier(s) to inventory items. As an example, the one or more reusable unique order identification code(s) or numeric identifier(s) can be dynamically determined based in part on information that is specific to the customers' requests (e.g., based in part on the one or more independently specifiable order attributes, etc.), including without limitation such attributes as product, brand, color, size, width, flavor, temperature, etc. In further non-limiting aspects, a company can influence how the reusable unique order identification code(s) or numeric identifier(s) are assigned to inventory items. For example, in yet a further non-limiting aspect, a company can choose to group inventory items based on other considerations aside from the customer-specified one or more independently specifiable order attributes (e.g., product categories, top selling items, celebrity orders, etc.). For instance, Starbucks® could sell Michael Jordan's favorite coffee drink as #23 as an homage to his accomplishments and recognition of his well-known basketball jersey number.

According to still other non-limiting aspects, embodiments of the disclosed subject matter can facilitate preloading all or substantially all of the one or more reusable unique order identification code(s) or numeric identifier(s) into a company's order system. For instance, once the company's items (e.g., products, services, combinations of products, combinations of services, combinations of products and services, etc.) are assigned reusable unique order identification code(s) or numeric identifier(s) the one or more reusable unique order identification code(s) or numeric identifier(s) can be preloaded into the company's order system that includes a product mapping table, for example, to facilitate efficient product queries and/or identification. Accordingly, if new products are added later to the order system, if customers make requests concerning one or more independently specifiable order attributes, for example, specified by, selected by, or received from a user (e.g., customer, employee, staff, owner, proprietor, contractor, etc.), related to an inventory item (and associated reusable unique order identification code or numeric identifier) the company can chose to either dynamically determine or generate a new reusable unique order identification code or numeric identifier, assign a reusable unique order identification code or numeric identifier comprising a base number plus an offset, as described above, etc.

In various non-limiting embodiments, the disclosed subject matter can also facilitate printing a label, as described above, for example, which can comprise the inventory item's dynamically determined reusable unique order identification code or numeric identifier. Thus, the reusable unique order identification code or numeric identifier, printed on a label, for example, can be affixed to, adhered to, attached to or otherwise associated with the inventory item. In further non-limiting example, a label can also include data such as product name, information about the inventory item (e.g., a list of ingredients or options) and/or other optional items (date, company name, bar code, etc.). In addition, further non-limiting embodiments of the disclosed subject matter can facilitate providing a tear portion on a label that includes the reusable unique order identification code or numeric identifier. As a non-limiting example, a reusable unique order identification code or numeric identifier can be included on the tear portion of the label, to facilitate removal and retention by the customer, such as for future use in subsequent ordering of the same inventory item, product, service, etc. at a later date.

As mentioned above, the disclosed subject matter can provide new systems, devices, and methodologies that can help to remove some of the guess work and many of the factors which can lead to human error and resulting failures in service based transactions. According to a non-limiting aspect, embodiments of the disclosed subject matter can generate, determine, assign, communicate, transmit, retrieve, analyze, act upon, or otherwise process a dynamically determined reusable unique order identification code or numeric identifier. According to a further non-limiting aspect, embodiments of the disclosed subject matter can generate, determine, assign, communicate, transmit, retrieve, analyze, act upon, or otherwise process a non-unique order identification code or numeric identifier (e.g., repetitive order identification code, a base reusable unique order identification code or numeric identifier suitable for use with offset values, etc.). Thus, it can be understood that the various exemplary embodiments of the disclosed subject matter can provide a new way to identify and code items (e.g., product, service, combinations of products, combinations of services, combinations of products and services, etc.) in a manner that is designed with the customer desires in mind.

Thus, in various non-limiting embodiments, aspects of the disclosed subject matter can comprise or be associated with creating a database, inputting data into the database, assigning one or more reusable unique order identification code or numeric identifier (e.g., dynamically determined reusable unique order identification code or numeric identifier, or otherwise) to data, retrieving data, analyzing data, applying algorithms on data, making or directing actions based in part on data, analysis thereof, and so on, reporting data, etc. Thus, various embodiments can provide dynamically determined reusable unique order identification code(s) or numeric identifier(s) that a customer can use to order or request an item including all of its detailed options (e.g., an item that conforms to the customer's desires with regard to one or more independently specifiable order attributes related to the item). In various non-limiting embodiments, it can be further understood that a reusable unique order identification code or numeric identifier can be conveniently and efficiently reused when a customer needs to reorder the same item or items from a company periodically (e.g., month after month, week after week, or day after day, etc.). In one aspect, various embodiments can include implementations that do not include pricing, whereas in other aspects, the reusable unique order identification code(s) or numeric identifier(s) can include or be associated with further information (e.g., customer information such as billing and payment information, coupon information, discount information, rewards clubs or plans, gift card information, etc.).

Accordingly, various aspects of the disclosed subject matter can address desires and wishes of customers who rightfully expect or demand that they receive the exact item they ordered, or the exact item they were expecting in a repeatable way. Thus, in various aspects, exemplary embodiments of the disclosed subject matter can comprise methodologies, systems, and/or devices that facilitate generating, determining, and assigning a reusable unique order identification code or numeric identifier to an order (e.g., an order for products, services, and so on, etc.). In further non-limiting aspects, exemplary embodiments of the disclosed subject matter can include methodologies, systems, and/or devices that facilitate printing and affixing, adhering, or attaching a label to, or otherwise associating a label with (e.g., a label having data associated with a identification code, a numeric identifier, etc.) one or more items comprising an order or a representation thereof (e.g., representations of products, services, etc.). In still other non-limiting aspects, methodologies, systems, and/or devices are provided that can employ one or more algorithm(s) that facilitate determining or generating a reusable unique order identification code or numeric identifier (e.g., a reusable numeric identifier or identification code, a custom numeric identifier or identification code, a dynamic numeric identifier or identification code, a reusable unique order identification code or numeric identifier for use with a value offset, etc.) related to an order, a prospective order, and so on, etc.

In other non-limiting aspects, exemplary embodiments of the disclosed subject matter can include methodologies, systems, and/or devices that facilitate providing kiosks, user terminals, communication components, portion or subcomponents thereof, or other facilities in suitable locations (e.g., at storefront entry ways, in retail establishments, over the internet, etc.) that can facilitate one or more of generating, determining, assigning, communicating, transmitting, retrieving, analyzing, acting upon, or otherwise processing a dynamically determined reusable unique order identification code or numeric identifier or data associated therewith concerning an order, a prospective order, and/or a representation thereof (e.g., representations of products, services, etc.).

### Exemplary Methodologies

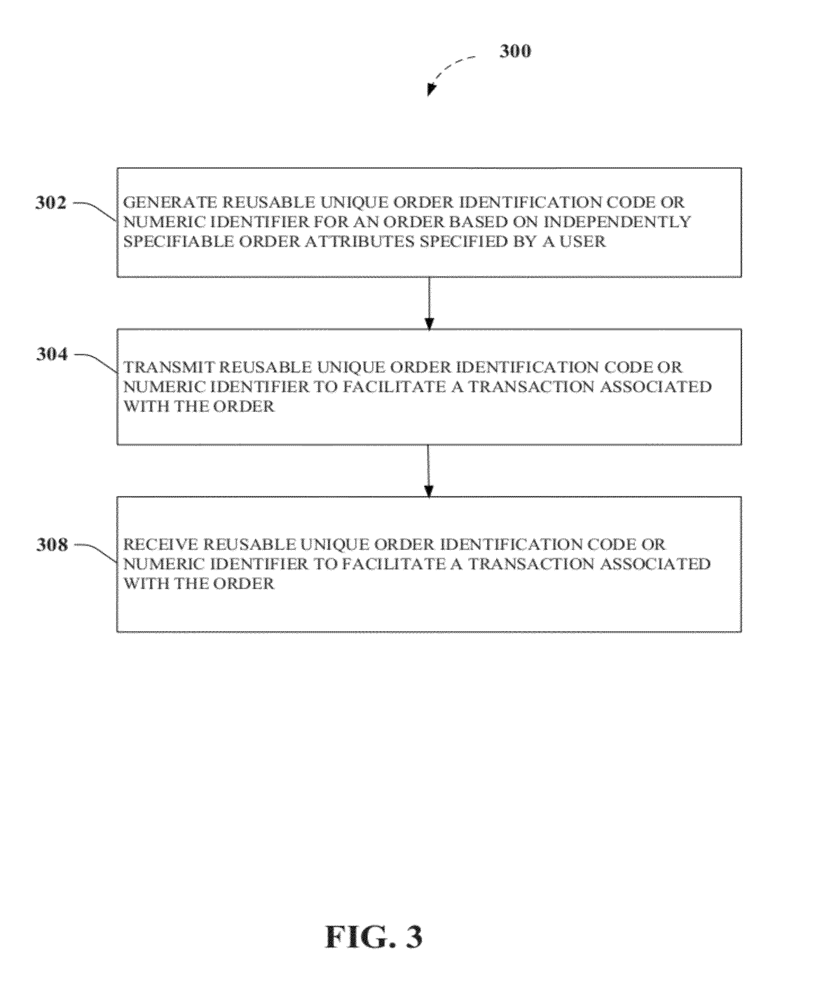

Accordingly, in view of the exemplary embodiments described supra, methodologies that can be implemented in accordance with the disclosed subject matter will be better appreciated with reference to the flowcharts of FIGS. 3-5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methodologies described hereinafter.

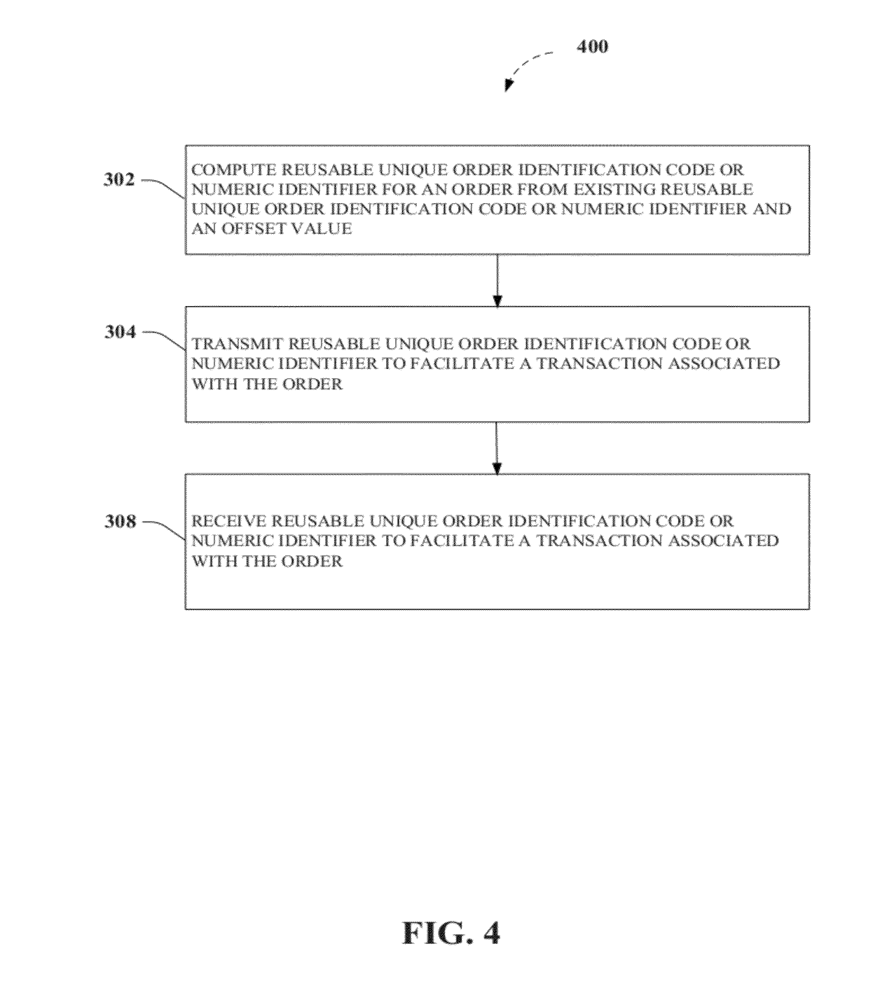

FIGS. 3 and 4 depict various aspects of exemplary non-limiting methodologies 300 and 400 for performing aspects of embodiments of the disclosed subject matter. For instance, referring to FIG. 3, at 302 of methodologies 300, a reusable unique order identification code or numeric identifier for an order can be generated or determined, as described herein, based at least in part on a plurality of independently specifiable order attributes specified by, selected by, or received from a user. For example, generating a reusable unique order identification code or numeric identifier for an order can include dynamically determining the reusable unique order identification code or numeric identifier for the order. In addition, at 304, methodologies 300 can further comprise transmitting the reusable unique order identification code or numeric identifier to facilitate one or more transaction(s) associated with the order. As an example, the reusable unique order identification code or numeric identifier can be transmitted to the user or from the user. Methodologies 300 can further include, at 306 receiving the reusable unique order identification code or numeric identifier for the order to facilitate one or more transaction(s) associated with the order. As a further example, the reusable unique order identification code or numeric identifier can be received from the user or otherwise. Moreover, methodologies 300 can further comprise analyzing the reusable unique order identification code or numeric identifier, in addition to determining the plurality of independently specifiable order attributes specified by, selected by, or received from the user, and fulfilling the order.

In further exemplary implementations, referring to FIG. 4, at 402 of methodologies 400, a reusable unique order identification code or numeric identifier for an order can be generated or determined, as described herein, based at least in part on a plurality of independently specifiable order attributes specified by, selected by, or received from a user. For example, generating a reusable unique order identification code or numeric identifier for an order can include dynamically determining the reusable unique order identification code or numeric identifier for the order. Moreover, the dynamically determining at 402 of methodologies 400 can include computing the reusable unique order identification code or numeric identifier from an existing reusable unique order identification code or numeric identifier and an offset value, for example, based in part one or more difference(s) from an item associated with the existing reusable unique order identification code or numeric identifier, and one or more attribute(s) of the plurality of independently specifiable order attributes specified by, selected by, or received from the user. In addition, at 404, methodologies 400 can further comprise transmitting the reusable unique order identification code or numeric identifier to facilitate one or more transaction(s) associated with the order. As an example, the reusable unique order identification code or numeric identifier can be transmitted to the user or from the user. Methodologies 400 can further include, at 406 receiving the reusable unique order identification code or numeric identifier for the order to facilitate one or more transaction(s) associated with the order. As a further example, the reusable unique order identification code or numeric identifier can be received from the user or otherwise. Moreover, methodologies 400 can further comprise analyzing the reusable unique order identification code or numeric identifier, in addition to determining the plurality of independently specifiable order attributes specified by, selected by, or received from the user, and fulfilling the order.

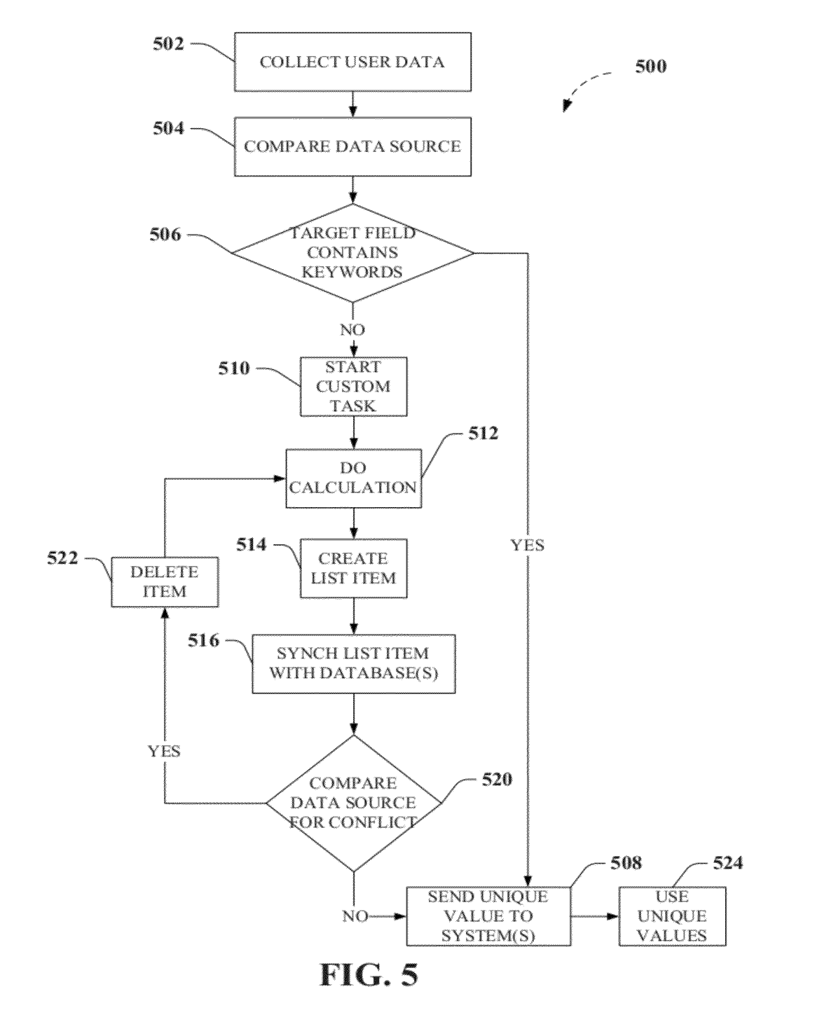

FIG. 5 depicts an exemplary non-limiting process flow diagram illustrating various aspects of exemplary methodologies 500 for dynamic determination or generation of one or more reusable unique order identification code(s) or numeric identifier(s) for an order based in part on the one or more independently specifiable order attributes specified by, selected by, or received from a user. For instance, as further described herein, various non-limiting implementations can employ exemplary methodologies 500, portions, and/or variants thereof.

As a non-limiting example, methodologies 500 can comprise obtaining or collecting user data at 502. In an exemplary implementation, a user can specify and exemplary systems and/or devices can collect user data comprising one or more pieces of data or information associated with an order or a prospective order (e.g., such as data or information including one or more of dynamically determined or generated reusable unique order identification code or numeric identifier for the order, one or more attribute(s) of a plurality of independently specifiable order attributes specified by, selected by, or received from a user, copies thereof, and so on, other pieces of ancillary data or information such as item information, pricing information such as current pricing information, billing and payment information, merchant information, manufacturer information, seller information, contact information, etc.).

In addition, at 504, methodologies 500 can further include comparing a subset of the collected user data with an established data source such as a database or other compilation of previously generated reusable unique order identification code(s) or numeric identifier(s) for the order, a corresponding one or more attribute(s) of a plurality of independently specifiable order attributes that can be specified by, selected by, or received from a user according to the established data source, etc. For instance, in a particular non-limiting implementation it can be established that particular target fields of a data set contain particular keywords indicating such things as the presence in the data set of a reusable unique order identification code or numeric identifier, a corresponding one or more attribute(s) of a plurality of independently specifiable order attributes that can be specified by, selected by, or received from a user, etc. Thus, at 506, it can be determined whether any target fields in the data set contain keywords.

If any target fields in the data set contain keywords, for example, indicating the presence in the data set of a reusable unique order identification code or numeric identifier, then the reusable unique order identification code or numeric identifier (and the corresponding one or more attribute(s) of a plurality of independently specifiable order attributes that can be specified by, selected by, or received from a user) can be sent to one or more exemplary system(s) (e.g., order systems) at 508, as described herein, that can employ the reusable unique order identification code or numeric identifier. If the target fields in the data set do not contain keywords, for example, indicating the presence in the data set of a reusable unique order identification code or numeric identifier, then a subset of the user data collected at 502 (e.g., the one or more attribute(s) of a plurality of independently specifiable order attributes that can be specified by, selected by, or received from a user according to the established data source) can be further processed.

For instance, at 510, a custom task can be commenced, for example, to perform any necessary preprocessing and/or housekeeping tasks. In addition, at 512, a calculation can be performed to facilitate generating or determine a prospective reusable unique order identification code or numeric identifier for the order. That is, until the prospective reusable unique order identification code or numeric identifier has been cleared of data source conflicts, then it can be defined as a prospective reusable unique order identification code or numeric identifier. Thus, at 514, methodologies 500 can include creating a list item associated with the subset of the user data collected at 502, and the list item can be synched with one or more database(s) as a prelude to determining if there are any data source conflicts, at 520.

If it is determined at 520, that there are no conflicts, then the reusable unique order identification code or numeric identifier (and the corresponding one or more attribute(s) of a plurality of independently specifiable order attributes that can be specified by, selected by, or received from a user) can be sent to one or more exemplary system(s) (e.g., order systems) at 508, as described herein, that can employ the reusable unique order identification code or numeric identifier. However, if it is determined at 520, that there are data source conflicts, then the item can be deleted at 522 and the process can proceed. As a further non-limiting example, if there is a potential conflict at 520, the exemplary systems components or portions thereof can resolve conflicts by synchronizing systems and comparing data sources to protect the product identification uniqueness, if desired according to the relevant scope of application as further described herein.

In addition, at 524, methodologies 500 can include employing the generated reusable unique order identification code(s) or numeric identifier(s) for the order and the corresponding one or more attribute(s) of a plurality of independently specifiable order attributes that can be specified by, selected by, or received from a user according to the established data source to successfully complete service-based transaction as described herein.

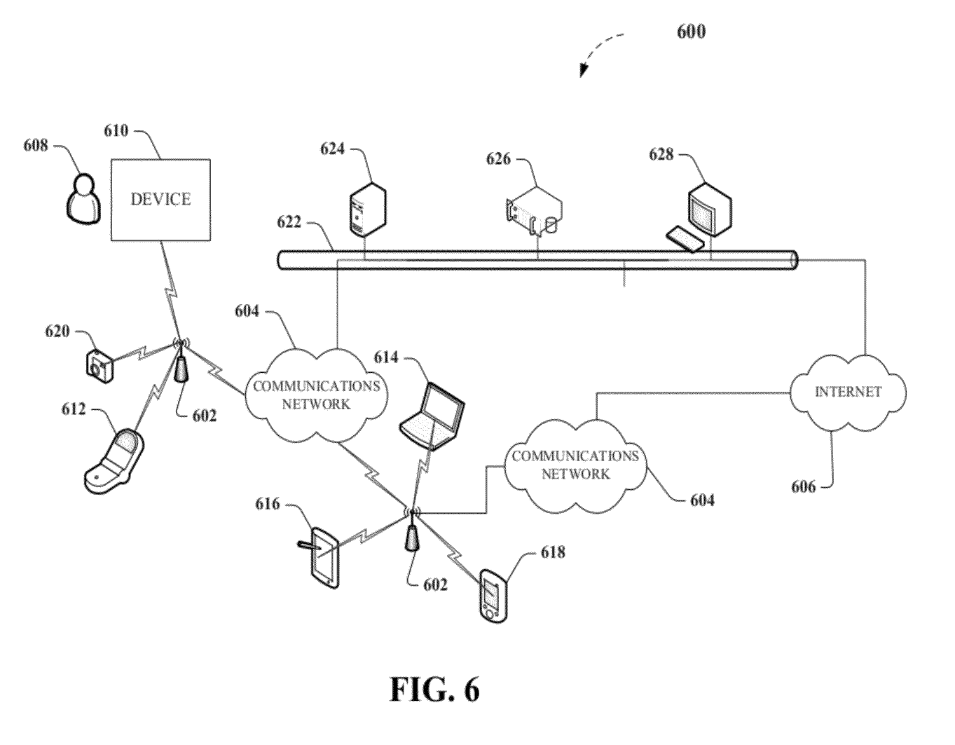

In view of the methodologies described supra, systems and devices that can be implemented in accordance with the disclosed subject matter will be better appreciated with reference to the functional block diagrams of FIGS. 6-13. While, for purposes of simplicity of explanation, the functional block diagrams are shown and described as various assemblages of functional component blocks, it is to be understood and appreciated that such illustrations or corresponding descriptions are not limited by such functional block diagrams, as some implementations may occur in different configurations. Moreover, not all illustrated blocks may be required to implement the systems and devices described hereinafter.

### Exemplary Systems and Devices

FIG. 6 illustrates an overview of an exemplary computing environment 600 suitable for incorporation of embodiments of the disclosed subject matter. For example, computing environment 600 can comprise wired communication environments, wireless communication environments, and so on. As a further example, computing environment 600 can further comprise one or more of a wireless access component 602, communications networks 604, the internet 606, etc., with which a user 608 can employ a variety of devices (e.g., device 610, devices 612-620, 622-628 to communicate information over a communication medium (e.g., a wired medium 622, a wireless medium, etc.) according to an agreed protocol.

Accordingly, computing environment 600 can comprise a number of components to facilitate the dynamic determination or generation of one or more reusable unique order identification code(s) or numeric identifier(s), the transmitting, receiving or otherwise communicating the one or more reusable unique order identification code(s) or numeric identifier(s) to facilitate one or more transaction(s) associated with the order, and the analyzing the reusable unique order identification code(s) numeric identifier(s), determining the plurality of independently specifiable order attributes specified by, selected by, or received from the user of devices according to various aspects of the disclosed subject matter, among other related functions. While various embodiments are described with respect to the components of computing environment 600 and the further embodiments more fully described below, one having ordinary skill in the art would recognize that various modifications could be made without departing from the spirit of the disclosed subject matter. Thus, it can be understood that the description herein is but one of many embodiments that may be possible while keeping within the scope of the claims appended hereto.

Additionally, while device 610 is shown as a generic network capable device, device 610 is intended to refer to a class of network capable devices that can one or more of receive, transmit, store, etc. information incident to and that user 608 can use to facilitate various techniques of the disclosed subject matter. While for purposes of illustration, the user 608 is described as performing certain actions, it is to be understood that device 610 (e.g., via an operating system, application software, device drivers, communications stacks, etc.) can perform such actions on behalf of the user.

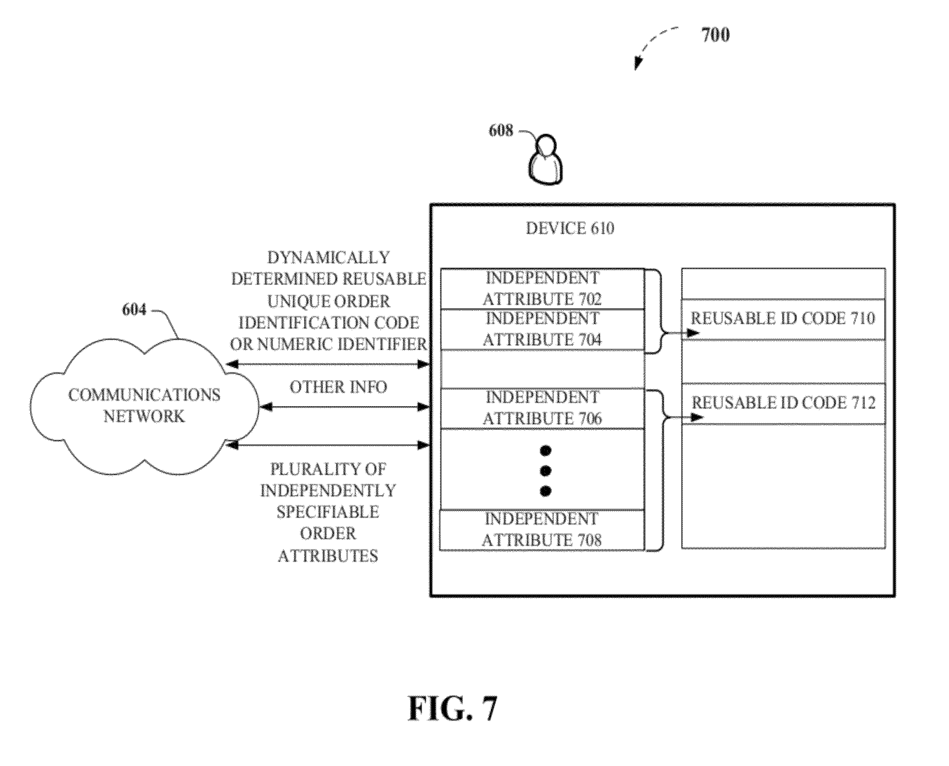

Accordingly, exemplary device 610 can include, without limitation, a cellular phone 612 connected to the network via access component 602 or otherwise, a laptop computer 614, a tablet personal computer (PC) device 616, and/or a personal digital assistant (PDA) 618, or other mobile device, and so on. As further examples, device 610 can include such devices as a network capable camera 620 and other such devices (not shown) as a pen computing device, portable digital music player, home entertainment devices, network capable devices, appliances, kiosks, and sensors, and so on. It is to be understood that device 610 can comprise more or less functionality than those exemplary devices described above as the context requires and as further described below in connection with FIGS. 7-11.

According to various embodiments of the disclosed subject matter, the device 610 can connect to other user devices to facilitate accomplishing various functions as further described herein. In addition, device 610 can connect via one or more communications networks 604 to a wired network 622 (e.g., directly, via the internet 606, or otherwise).

Wired network 622 (as well as communications network 604) can comprise any number of computers, servers, intermediate network devices, and the like to facilitate various functions as further described herein. As a non-limiting example, wired network 622 can include a merchant server 624 (e.g., a retailer, a car manufacturer, car dealer or rental car establishment, server, kiosk, network attached computer, etc.) as described above, that facilitates querying, selecting, specifying, customizing, items item (e.g., product, service, combinations of products, combinations of services, combinations of products and services, etc.) or one or more of the plurality of independently specifiable order attributes specified by, selected by, or received from user 608. In addition, merchant server 624 can facilitate dynamic determination or generation of one or more reusable unique order identification code(s) or numeric identifier(s), transmitting, receiving or otherwise communicating the one or more reusable unique order identification code(s) or numeric identifier(s) to facilitate one or more transaction(s) associated with the order.

Merchant server 624 can further include any number of intermediaries acting on behalf of one or more merchants, retailers, manufacturers, customers, or other service-based transaction participants or third parties to facilitate various functions as further described herein. In a further non-limiting example, an intermediary acting on behalf a merchant or group of affiliated merchants could store and provide access to information including one or more of reusable unique order identification code(s) or numeric identifier(s), associated order descriptions, associated pluralities of independently specifiable order attributes specified by, selected by, or received from the one or more user(s) 608 to facilitate synching a set of data comprising the information across disparate merchants. As a further example, such data sets could be stored on a server 626 to facilitate the syncing function.

In addition, wired network 622 can facilitate performing ancillary functions to accomplish various techniques described herein. For example, computer 628 can provide functions such as authentication and authorization of user 608, inventory management, storage of root or existing reusable unique identification codes or numeric identifiers and offsets, facilitating purchase transaction(s), etc. According to various non-limiting embodiments of the disclosed subject matter, computing environment 600 can further comprise additional network components (not shown). For example, device 610 and/or other components can be relatively simplistic and lacking certain features to facilitate various techniques of the disclosed subject matter. Accordingly, particular aspects of the disclosed subject matter can be facilitated by additional network components (not shown) in communication with device 610 and/or other components.

For instance, merchant server 624 can be capable of facilitating the analysis of the reusable unique order identification code(s) numeric identifier(s) and/or determining the plurality of independently specifiable order attributes specified by, selected by, or received from user 608, but be unable to authenticate a user 608 or verify that access is authorized (e.g., verifying fulfillment of a specified requirement) in embodiments that would employ such techniques. Accordingly, computing environment 600 can comprise such further components (not shown) (e.g., authentication, authorization and accounting (AAA) servers, e-commerce servers, database servers, application servers, etc.) in communication with merchant server 624 and/or user 608 to accomplish the desired functions.

FIG. 7 illustrates an exemplary non-limiting block diagram showing illustrative aspects of embodiments of the disclosed subject matter in the context of storing, transmitting, receiving or otherwise communicating information comprising one or more of the plurality of independently specifiable order attributes (e.g., independent attributes 702, 704, 706, 708, etc.) specified by, selected by or received from the user, one or more reusable unique order identification code(s) or numeric identifier(s) (e.g., one or more and reusable ID codes 710, 712, etc.) based in part on the information, and other information incident to a transaction (e.g., item information, pricing information, billing and payment information, merchant information, manufacturer information, seller information, contact information, etc.). According to an aspect of the disclosed subject matter, in consideration of the increasing pervasiveness of electronic devices, order system 700 provides an infrastructure in which a variety of embodiments of the disclosed subject matter can facilitate successful service-based transactions as described herein.

For example, in addition to the scenarios described above with respect to labels and tear away portions comprising a dynamically determined reusable unique order identification code or numeric identifier, various embodiments of exemplary order system 700 can facilitate, among other things, storing transmitting, receiving or otherwise communicating the one or more reusable unique order identification code(s) or numeric identifier(s) to facilitate one or more transaction(s) associated with the order; and analyzing the reusable unique order identification code(s) numeric identifier(s), determining the plurality of independently specifiable order attributes specified by, selected by, or received from the user.

As a further example, further non-limiting embodiments of exemplary order system 700 can facilitate, among other things, dynamic determination or generation of one or more reusable unique order identification code(s) or numeric identifier(s), as described below. It can be understood that while various activities and functions are described with respect to a user 608, device 610, network 604, components, subcomponents, etc., it is to be appreciate that any number of such activities, functions, or portions thereof, can be delegated to intermediaries authorized to act on behalf of the respective entities or components, subcomponents. It can be further understood that any of the specified functions or portions thereof can be performed by authorized computing process either in a manual, automated, or interactive manner or any combination thereof.

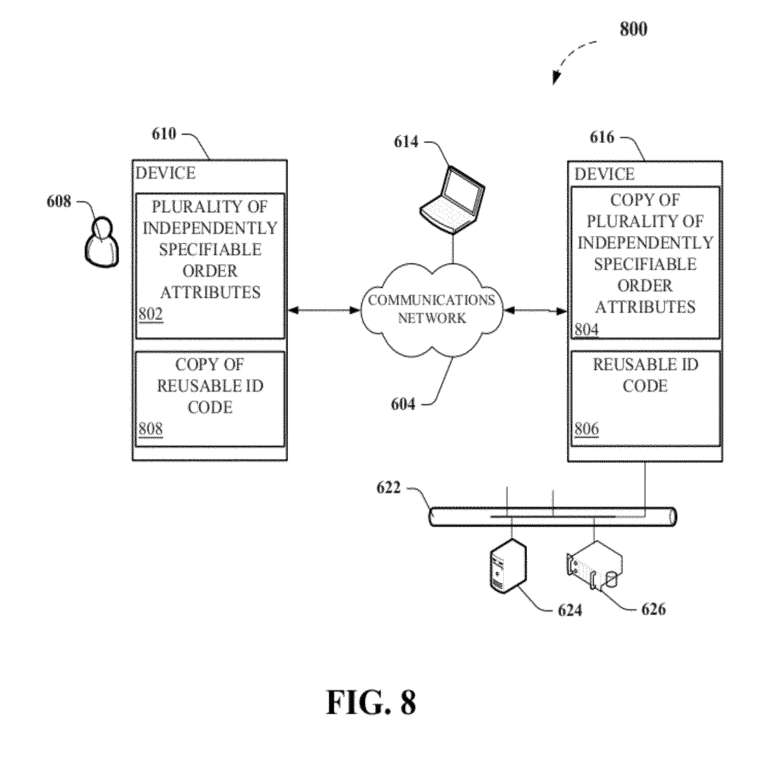

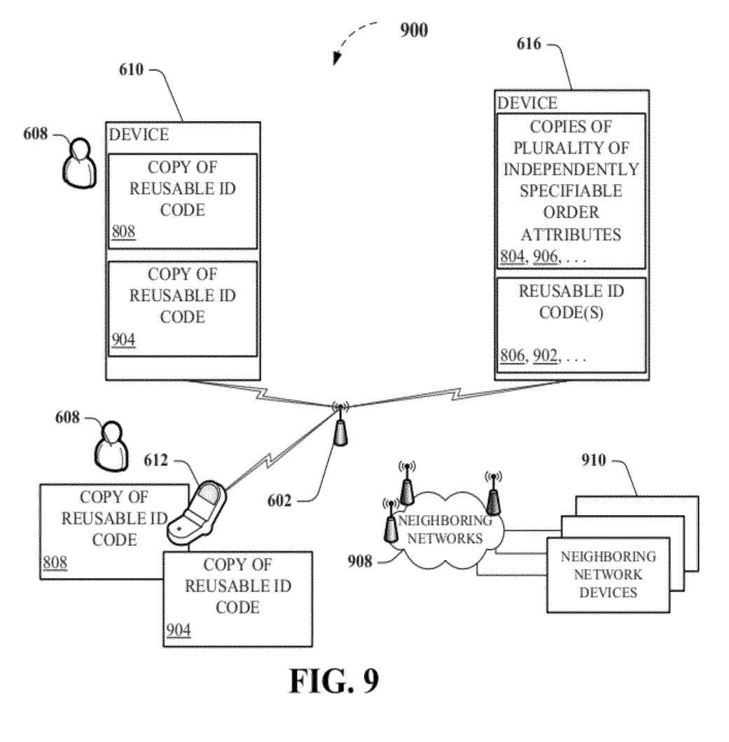

FIGS. 8-9 illustrate an exemplary non-limiting block diagram of an exemplary non-limiting implementation of order systems 800 and 900 according to various embodiments of the disclosed subject matter. For example, order systems 800 and 900 can comprise one or more components of computing environment 600 that can facilitate functions, techniques, methodologies, or portions thereof as described herein. For instance, in the exemplary order system 800, device 610 can be communicatively coupled to device 616. In various embodiments, user 608, desiring to order an item having one or more independently specifiable order attributes that can be specified, selected, or received from user 608 can employ device 610, as a non-limiting example, to query, browse, sort, etc., the various independently specifiable order attributes, and as a result, can employ device 610 to capture the selection or specification of the one or more independently specifiable order attributes (e.g., via a touch screen device, a alphanumeric keypad, a pointing device such as a mouse or joystick, etc.). Thus, the selection or specification of the one or more independently specifiable order attributes can be communicated to other devices, for example, a device 616 acting as a merchant device (e.g., a device associated with a merchant, etc.) that the user 608, after selection or specification of the one or more independently specifiable order attributes, can indicate a desire to transact with via communications network 604.

Accordingly, it can be seen in FIG. 8 that the plurality of independently specifiable order attributes 802 can be transmitted from device 610 and can be received by device 616 as a copy of plurality of independently specifiable order attributes 804. Upon determination of whether the set of the attributes (e.g., the plurality of independently specifiable order attributes 802 as represented by the copy of plurality of independently specifiable order attributes 804) exists in order system 800, order system 800 can facilitate dynamically determining or generating a reusable unique order identification code or numeric identifier for the order (e.g., reusable ID code 806).

It can be understood that, depending on whether the set of the attributes (e.g., the plurality of independently specifiable order attributes 802 as represented by the copy of plurality of independently specifiable order attributes 804) exists in order system 800, a reusable unique order identification code or numeric identifier for the order (e.g., reusable ID code 806) can be looked up in a database (e.g., on server 626, on a local server operating in device 616), in a lookup table, in local memory, or it can be dynamically generated or determined via an algorithm as described above (e.g., via device 616, merchant server 624, server 626, etc.). Accordingly, the dynamically determined or generated reusable unique order identification code or numeric identifier for the order (e.g., reusable ID code 806) can then be transmitted via communications network 604 to device 610. Thus, the dynamically determined or generated reusable unique order identification code or numeric identifier for the order (e.g., reusable ID code 806) can be received by device 610 as a copy of the dynamically determined or generated reusable unique order identification code or numeric identifier for the order (e.g., copy of reusable ID code 808).

It can be understood that device 610 can then retain the plurality of independently specifiable order attributes 802, or they can be discarded as desired. However, in the event that the user 608 determines that he or she would like to place the order represented by copy of reusable ID code 808 again, then user 608 can retain one or more of the plurality of independently specifiable order attributes 802 and the copy of reusable ID code 808. In this instance, one or more of the copy of reusable ID code 808 and the plurality of independently specifiable order attributes 802 can be stored, or otherwise retained for future use by user 608. In contrast, device 616 acting as a merchant device (e.g., a device associated with a merchant, etc.) can retain (e.g., via device 616, merchant server 624, server 626, etc.) both of the reusable ID code 806 and the copy of the plurality of independently specifiable order attributes 804, to facilitate efficient retrieval of the plurality of independently specifiable order attributes 804 when receiving a future order facilitated by a transmitted copy of reusable ID code 808.

For instance, according to further aspects of the disclosed subject matter, order system 900 demonstrates how the various embodiments of the disclosed subject matter can facilitate successful and efficient service-based transactions. For instance, consider repeat customers (e.g., users 608) represented in FIG. 9 by devices 610 and 612. After having satisfied themselves that the order item as represented by copy of the dynamically determined or generated reusable unique order identification code or numeric identifier for the order (e.g., copy of reusable ID code 808), the customers merely need to commence a transaction by, for example, communicating with another device, such as device 616 acting as a merchant device (e.g., a device associated with a merchant, etc.). For example, devices 610 and 612 can transmit its respective copy of the dynamically determined or generated reusable unique order identification code or numeric identifier for the order (e.g., copy of reusable ID code 808) to device 616 (e.g., wireless access component 602) as part of the transaction process. Upon receipt of the respective copies of reusable ID code 808, device 616, having previously transacted with device 610 with regard to reusable ID code 806 and the associated copy of reusable ID code 808, merely has to look up the copy of the plurality of independently specifiable order attributes 804 in a database (e.g., on server 626 of FIG. 8, on a local server operating in device 616), in a lookup table, in local memory, etc.

Order system 900 of FIG. 9 demonstrates further advantages and inherent benefits of various non-limiting implementations of the disclosed subject matter. Referring again to the scenario described above in which a runner is collecting coffee orders for an office, FIG. 9 illustrates that devices suitable for use with the various embodiments of the disclosed subject matter (e.g., device 610, device 612, etc.) can store, receive, and/or transmit one or more of the set of the plurality of independently specifiable order attributes (e.g., plurality of independently specifiable order attributes 802, etc.) and/or one or more of the associated copies of the dynamically determined reusable unique order identification code or numeric identifier (e.g., copy of reusable ID code 808, 904, etc.). Insofar as a communicatively coupled device, such as device 616 acting as a merchant device (e.g., a device associated with a merchant, etc.) has the corresponding set of the copies of the plurality of independently specifiable order attributes (e.g., copies of the plurality of independently specifiable order attributes 804, 906, . . . , etc.) and the set of the associated copies of the dynamically determined reusable unique order identification code or numeric identifier (e.g., copy of reusable ID code 806, 902, etc.), then a transaction via the various embodiments of the disclosed subject matter can proceed. That is, so long as device 616 can ‘lookup’ the respective ‘recipes’ (e.g., copies of the plurality of independently specifiable order attributes 804, 906, . . . , etc.) for the corresponding ‘codes’ (e.g., copy of reusable ID code 806, 902, etc.), then the transaction could proceed successfully via the disclosed techniques.

However, FIG. 9 illustrates further advantages and aspects of the various embodiments of the disclosed subject matter. For example, consider a scenario of multiple merchants of the same company or similar businesses, of which the merchants are densely packed in an urban area (e.g., Starbucks®, etc.). It can be understood that if every customer had a separately unique and dynamically generated or determined reusable unique order identification code or numeric identifier for each store, the results in the overall order system could be highly redundant and difficult to manage. In addition, as pervasive as wireless communication has become, the need to discriminate between neighboring merchants (e.g., neighboring networks 908, neighboring network devices 910, etc.) can provide additional benefits.

Accordingly, in various non-limiting implementations, as described above, embodiments of the disclosed subject matter can employ techniques of dynamically generating or determining reusable unique order identification code(s) or numeric identifier(s) as a result of a previously existing reusable unique order identification code or numeric identifier plus an offset value (e.g., previously existing reusable unique order identification code or numeric identifier +1, etc.). Thus, in various aspects, non-limiting embodiments of order systems 800 and 900 can compute an offset value based in part on one or more difference(s) from an item associated with an existing reusable unique order numeric identifier and one or more of the plurality of independently specifiable order attributes specified by, selected by, or received from the user.

For example, suppose that generally, Starbucks® determines a unique order identification code or numeric identifier for a Grande Americano with room and light ice as 3AWRLI. Thus, a customer could, according to the various embodiments of the disclosed subject matter, transmit the identification code or numeric identifier 3AWRLI as part of an order at a Starbucks® location (e.g., by scanning a receipt from a prior purchase at a kiosk or point of sale terminal, by transmission of the unique order identification code or numeric identifier from a user via a device and reception of the transmission by the location via another device, etc.). However, recognizing that there may be more than one Starbucks® within communication range of the device of the user according to a selected protocol, the identification code or numeric identifier with an offset value a location at 1st and Pine could be 3AWRLI+1P, whereas at 5th and Pine, the offset could be +5P. In a further non-limiting example, suppose that various coffee houses or companies agree that a semi-standardized identification code or numeric identifier order system is in their collective best interests (e.g., higher productivity for participants, etc.), suitable additional or alternative offsets could include +S or +SBC, or some other numeric or alphanumeric offset values, to indicate for example, Starbucks® and Seattle's Best Coffee®, respectively.

Accordingly, in at least one aspect of various embodiments of the disclosed subject matter, a dynamically generated or determined reusable unique order identification code or numeric identifier can comprise hierarchical information, or representations thereof (e.g., hashes, encrypted information, obfuscated information, etc.), that can associated with (e.g., be resolved or computed into, etc.) a plurality of independently specifiable order attributes specified by, selected by, or received from a user. For instance, in the examples above, a dynamically generated or determined reusable unique order identification code or numeric identifier, 3AWRLISBC5P, can resolve into the plurality of independently specifiable order attributes comprising Grande (e.g., where “1” can resolve to Short, “2” can resolve to Tall, “3” can resolve to Grande, and so on, etc.), Americano (e.g., where “A” can resolve to “Americano,” “L” can resolve to “Latte,” “M” can resolve to “Mocha,” and so on, etc.), With Room (e.g., where “WR” can resolve to “With Room,” “NR” can resolve to “No Room,” and so on, etc.), Light Ice (e.g., where “LI” can resolve to “Light Ice,” “ES” can resolve to “Extra Shot,” “2S” can resolve to “2 Extra Shots,” and so on, etc.). In addition, the portion of the dynamically generated or determined reusable unique order identification code or numeric identifier, SBC5P, can resolve into the plurality of independently specifiable order attributes comprising Seattle's Best Coffee® (e.g., where “SBC” can resolve to “Seattle's Best Coffee®,” “S” can resolve to “Starbucks®,” and so on, etc.) and 5th and Pine (e.g., where “5P” can resolve to “5th and Pine,” “1P” can resolve to “5th and Pine,” and so on, etc.). Thus, the dynamically generated or determined reusable unique order identification code or numeric identifier, 3AWRLISBC5P, can comprise hierarchical information that can be resolved or computed into a plurality of independently specifiable order attributes specified by, selected by, or received from a user. In addition, it can be understood that any of the set of the plurality of independently specifiable order attributes as represented by the portions of the dynamically generated or determined reusable unique order identification code or numeric identifier (e.g., one or more of “3,” “A,” “W,” “R,” “LI,” “SBC,” or “5P,” and so on, etc.), and combinations thereof, can be hashed, encrypted, obfuscated, or otherwise processed to facilitate providing privacy and/or security. In further aspects of various exemplary embodiments, the hierarchical information or representations thereof can be associated with information that can describe one or more available options for an item, for independently specifiable order attributes, etc.

Thus, while the aforementioned examples are merely illustrative of the concepts and benefits afforded by the various disclosed embodiments, it is understood that the disclosed subject matter is not so limited. However, the aforementioned examples further illustrate the concept of uniqueness and its scope within the disclosed subject matter. For instance, as used herein, the term “unique” is to be understood and appreciated with respect to a relevant scope of application. For instance, in a global scope of application for an identification code or numeric identifier to be unique would imply that there are no others like it. In other words, a database lookup using a globally unique identification code or numeric identifier would return only one unambiguous result no matter how large the database. Recognizing practical limitations, it is more likely that a reduced scope of application would be implemented.

For example, an order system might be, given various considerations, appropriately scoped for a merchant or company on a geographical basis (e.g., coffee houses in Seattle, or western Washington, etc.) or other factor, rather than on an otherwise arbitrary scope. Thus, having a unique or locally unique identification code or numeric identifier would imply that, a database lookup using a locally unique identification code or numeric identifier would return only one unambiguous result within the reduced scope of application. It is recognized, of course, outside of the scope of application a locally unique identification code or numeric identifier could be non-unique in the conventional sense.

In addition, FIG. 9 further illustrates additional advantages and aspects of the various embodiments of the disclosed subject matter. For example, consider the scenario of multiple merchants in the same geographical region and/or similar businesses. In a further non-limiting example, suppose the multiple merchants agree that a semi-standardized identification code or numeric identifier order system is in their collective best interests (e.g., higher productivity for participants, etc.), order system 900 can facilitate a cooperative effort in establishing and/or maintaining the order system 900 (e.g., the set of unique identification code or numeric identifier and their corresponding sets of independent attributes, etc.), for example. For instance, due to a close proximity relative to the communication protocol selected, or other factors, order system 900 can facilitate communicating with neighboring network devices 910 via neighboring networks, for example.

Thus, in a further aspect of various non-limiting implementations of order systems as described herein, it can be understood that while the order system encoding of identification code(s) or numeric identifier(s) described above is relatively straightforward and transparent (e.g., 3AWRLI=Grande Americano with room and light ice, +1P=1st and Pine; +5P=5th and Pine, +S=Starbucks®, +SBC=Seattle's Best Coffee®, etc.). However, further non-limiting embodiments can employ various encoding, hashing, and/or encryption protocols (e.g., as described herein, or otherwise, etc.) to provide protection of the merchants investment and competitive advantage.

It can be understood that devices (e.g., device 610, etc.) can be relatively simplistic devices lacking certain features to facilitate one or more aspects of the disclosed subject matter. Thus, particular aspects of the disclosed subject matter can be facilitated by various network components (not shown) in a client-server model and/or peer-to-peer model in communication with device 610. It can be further understood that various functions, components, or process steps, and so on as described herein can be combined or distributed via techniques known in the art or can be eliminated or reorganized according to system design considerations without departing from the scope of the claims appended hereto. For example, while some of the functions (e.g., authentication of users and/or devices, storing, transmitting, receiving, or otherwise communicating information, determining and/or generating unique order identification code(s) or numeric identifier(s), etc.) can be described as occurring in discrete elements or devices for purposes of illustration, it should be understood that such functions can be combined or distributed as desired. As an example, for transmitting and/or receiving information (e.g. one or more of dynamically determined or generated reusable unique order identification code or numeric identifier for the order, the plurality of independently specifiable order attributes, copies thereof, etc.), some or all of the described functions can be facilitated between a device 616, merchant server 624, and so on over a communications network (e.g. communications network 604) with or without involving an intermediary. Further examples of such modifications will become apparent to those skilled in the art upon review of the various embodiments disclosed and claimed herein.

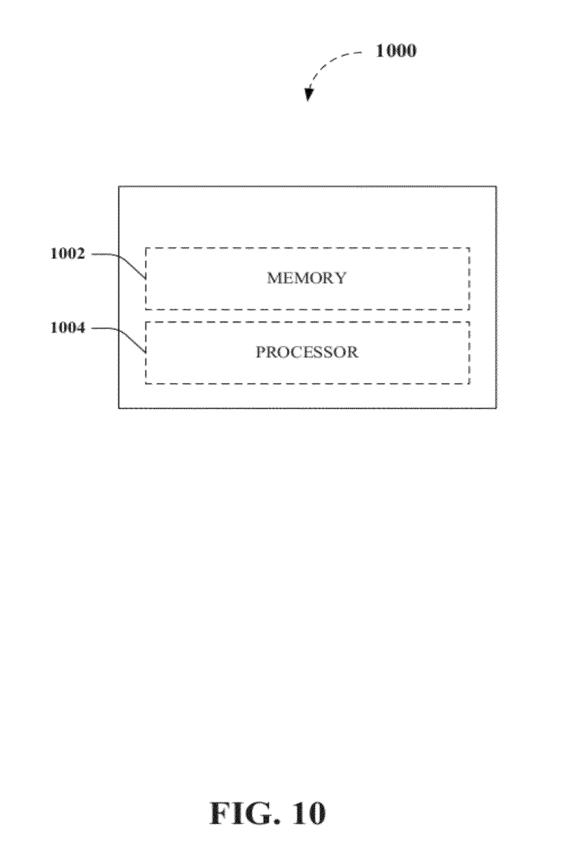

FIG. 10 illustrates an exemplary non-limiting device or system 1000 suitable for performing various aspects of the disclosed subject matter. The device or system 1000 can be a stand-alone device or a portion thereof or a specially programmed computing device or a portion thereof (e.g., a memory retaining instructions for performing the techniques as described herein coupled to a processor). Device or system 1000 can include a memory 1002 that retains various instructions with respect to facilitating transmitting or receiving a dynamically determined reusable unique order numeric identifier (e.g., a dynamically determined reusable unique order numeric identifier determined in part on information comprising one or more of independently specifiable order attributes as specified by, selected by, or received from a user for an order), analyze the reusable unique order numeric identifier and determining at least one of the plurality of independently specifiable order attributes specified by, selected by, or received from the user, transmitting or receiving the plurality of independently specifiable order attributes as specified by, selected by, or received from the user, printing a label comprising the reusable unique order numeric identifier, generating the dynamically determined reusable unique order numeric identifier, encryption and/or decryption and communications routines such as networking and peer-to-peer communications routines, and/or the like.

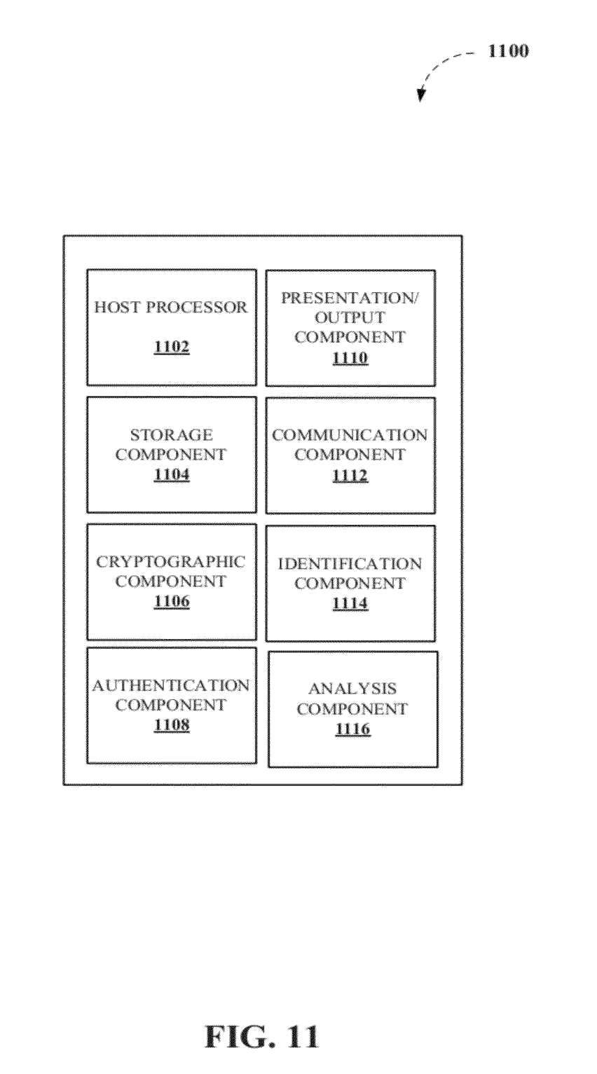

For instance, device or system 1000 can include a memory 1002 that retains instructions for transmitting or receiving a dynamically determined reusable unique order numeric identifier (e.g., a dynamically determined reusable unique order numeric identifier determined in part on information comprising one or more of independently specifiable order attributes as specified by, selected by, or received from a user for an order). Additionally, memory 1002 can retain instructions for transmitting or receiving the plurality of independently specifiable order attributes as specified by, selected by, or received from the user and generating the dynamically determined reusable unique order numeric identifier. In a further exemplary embodiment of device or system 1000, memory 1002 can retain instructions for receiving information comprising one or more independently specifiable order attribute(s) specified by, selected by, or received from a user for an order, dynamically determining a reusable unique order numeric identifier based in part on one or more independently specifiable order attribute(s), and transmitting the reusable unique order numeric identifier to the user to facilitate subsequent transactions by the user for an identical order. In a further example, memory 1002 can retain instructions for dynamically determining one or more reusable unique order identification code(s) or numeric identifier(s) including hierarchical information associated with one or more independently specifiable order attribute(s), for instance, as described herein. The above example instructions and other suitable instructions can be retained within memory 1002, and a processor 1004 can be utilized in connection with executing the instructions. Various aspects of non-limiting embodiments of device or system 1000 can be further understood by reference to FIGS. 11-14, for example.

FIG. 11 illustrates an exemplary non-limiting device or system 1100 suitable for performing various aspects of the disclosed subject matter. As briefly described above with reference to FIG. 6, for example, various non-limiting embodiments of the disclosed subject matter can comprise more or less functionality than those exemplary devices therein, depending on the context. In addition, a device or system 1100 as described can be any of the devices as the context requires and as further described above in connection with FIGS. 6-10. It can be understood that while the functionality of device or system 1100 is described in a general sense, more or less of the described functionality may be implemented, combined, and/or distributed (e.g., among network components, servers, databases, and the like), according to context, system design considerations, and/or marketing factors, and the like.

Thus, as described above, device or system 1100 can include host processor 1102 (e.g., processor 1004, etc.) that can be associated with a storage component 1104 to facilitate storage of data or information (e.g., information such as one or more of dynamically determined or generated reusable unique order identification code or numeric identifier for the order, the plurality of independently specifiable order attributes, copies thereof, etc.), and/or instructions for performing functions associated with an incident to the disclosed subject matter as described herein, for example, regarding FIG. 10. In addition, in exemplary non-limiting implementations, storage component 1104 of device or system 1100 can be configured to store one or more dynamically determined reusable unique order identification code(s) or numerical identifier(s) with at least one other dynamically determined reusable unique order identification code or numerical identifier to facilitate, for instance, propagation one or more dynamically determined reusable unique order identification code or numerical identifier with another device or system (e.g., device or system 1100, another order system, etc.).

In addition, the host processor 1102 can be associated with a cryptographic component 1106. In accordance with an aspect of the disclosed subject matter, cryptographic component 1106 can provide symmetric cryptographic tools and accelerators (e.g., Twofish, Blowfish, AES, TDES, IDEA, CASTS, RC4, etc.) to facilitate encrypting and/or decrypting data. Thus, cryptographic component 1106 can facilitate securing data being written to, stored in, and/or read from the storage component 1104 (e.g., such as information including one or more of dynamically determined or generated reusable unique order identification code(s) or numeric identifier(s) for the order, whether or not comprising hierarchical information associated with the plurality of independently specifiable order attributes, the plurality of independently specifiable order attributes, copies thereof, and so on, other information such as item information, pricing information such as current pricing information, billing and payment information, merchant information, manufacturer information, seller information, contact information, etc.), transmitted to or received from a connected network (e.g., such as for transmitting user associated information to a trusted intermediary, etc.), and/or creating a secure communication channel as part of a secure association of device or system 1100 with a user or systems facilitating various aspects of the disclosed subject matter to ensure that protected data can only be accessed by those entities authorized and/or authenticated to do so. To the same ends, cryptographic component 1106 can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, and so on).

Device or system 1100 can further include an authentication component 1108 that can solicit authentication data from a user 1108 or other device (e.g., an operating system and/or application software) on behalf of user 1108, and, upon receiving the proper authentication data so solicited, can be employed, individually and/or in conjunction with information acquired and ascertained as a result of biometric modalities employed, to facilitate associating network device with user 1108. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), and the like, for example.

Additionally and/or alternatively, public key infrastructure (PKI) data can also be employed by authentication component 1108. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

For example, a properly authenticated user 1108, in one aspect of the disclosed subject matter, upon proper authentication could, without further action other than selection or designation of a previously dynamically generated reusable unique order numeric identifier for an order (e.g., a dynamically generated reusable unique order numeric identifier based in part on information comprising a plurality of independently specifiable order attributes, etc.) for transmission, can be trusted by merchants, suppliers, business owners, etc. or one or more devices that act on their behalf and with which properly authenticated user 1108 has a pre-existing account (e.g., credit account, debit account, or otherwise) to commence and complete a service-based transaction according to the disclosed subject matter. Thus, the authentication component 1108 can further expedite successful service-based transactions by facilitating trust verification by the device 1100.

Accordingly, authentication component 1108 can implement one or more machine-implemented techniques to identify a user 1108 or other device (e.g., an operating system and/or application software) on behalf of user 1108, by the user's unique physical and behavioral characteristics and attributes. Biometric modalities that can be employed can include, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, and finger print identification that scans the corrugated ridges of skin that are non-continuous and form a pattern that can provide distinguishing features to identify an entity.

Referring again to FIG. 11, device or system 1100 can also include a presentation/output component 1110, which can be associated with the host processor 1102, and which can facilitate various aspects of the disclosed subject matter. For instance, the presentation/output component 1110 can provide various types of user interfaces to facilitate interaction between a user 1108 and any component coupled to the host processor 1102. In addition to providing one or more indications to facilitate selection or specification of independently specifiable order attributes for an item, selecting a previously dynamically generated reusable unique order numeric identifier for an order (e.g., a dynamically generated reusable unique order numeric identifier based in part on information comprising a plurality of independently specifiable order attributes, etc.) for transmission, and so on, as described above, presentation/output component 1110 can provide one or more graphical user interfaces (GUIs), command line interfaces, structured and/or customized menus, and the like.

For example, a GUI can be rendered that provides a user with a region or means to load, import, read, etc., data, and can include a region to present such results. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into the host processor 1102.

The user can also interact with the regions to select and provide information via various devices such as a mouse, a roller ball, a keypad, a keyboard, touchpad, touch screen, a pen and/or voice activation, for example. Typically, a mechanism such as a push button or the enter key on the keyboard can be employed to facilitate entering information in device 1100. However, it is to be understood that the claimed subject matter is not so limited. For example, merely highlighting a check box can initiate information conveyance.

In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be understood that a command line interface can be employed in connection with a GUI and/or API. In addition, the command line interface can be employed in connection with hardware (e.g., video cards of a computer) and/or displays (e.g., black and white, EGA, or other video display unit of a standalone device such as an LCD display on a network printer) with limited graphic support, and/or low bandwidth communication channels.

As a further example, device or system 1100 can include one or more motion sensors and associated software components and/or voice activation components that can be used by user 1108 to facilitate entering information in device or system 1100.

In yet another exemplary implementation, presentation/output component 1110 can facilitate printing a label comprising a reusable unique order numeric identifier for affixing the reusable unique order numeric to an associated order (e.g., via appropriate routines, protocols, connections, and so on for relaying print data to a suitable printing device, etc.).

Referring again to FIG. 11, device or system 1100 can further comprise a communication or communications component 1112, which can be associated with the host processor 1102, and which can facilitate various aspects of the disclosed subject matter. For instance, the communication or communications component 1112 can facilitate transmitting or receiving one or more reusable unique order identification code(s) or numeric identifier(s) (e.g., to or from a user, etc.) determined to facilitate one or more transaction(s) associated with the order, transmitting or receiving a plurality of independently specifiable order attributes as specified by, selected by, or received from a user, transmitting or receiving current pricing information associated with reusable unique order identification code(s) or numeric identifier(s), and the like.

In addition, device or system 1100 can comprise an identification component 1114, which can be associated with the host processor 1102, and which can facilitate various aspects of the disclosed subject matter. For instance, the identification component 1114 can be adapted to dynamically generate one or more reusable unique identification code(s) or order numeric identifier(s) for an order based in part on information comprising a plurality of independently specifiable order attributes. In a further example, the identification component can be further configured to dynamically generate one or more reusable unique order identification code(s) or numeric identifier(s) comprising hierarchical information associated with one or more independently specifiable order attribute(s), which can be based on an existing reusable unique order numeric identifier and an offset value. In yet another example, device or system 1100 can comprise an analysis component 1116, which can be associated with the host processor 1102, and which can facilitate various aspects of the disclosed subject matter. For example, the analysis component 1116 can be adapted to, among other things, analyze one or more reusable unique order identification code(s) or numeric identifier(s) (e.g., one or more dynamically determined reusable unique order identification cod(e) or numeric identifier(s), etc.) and/or determine one or more independently specifiable order attribute(s) specified by, selected by, or received from the user (e.g., one or more independently specifiable order attribute(s) that corresponds to a reusable unique order identification code or numeric identifier, that form a basis for a dynamically determined reusable unique order identification code or numeric identifier, etc.). In further non-limiting implementations, analysis component 1116 can be further configured to query an order system or device, for example, to determine whether the transaction can be completed (e.g., convert one or more of a dynamically determined reusable unique order identification code or numeric identifier a plurality of independently specifiable order attribute(s), etc. to a SKU, PLU, or other information that facilitates checking or recalling an item in inventory, and so on, etc.).

As depicted, device 1100 is described as a monolithic device or system. However, it is to be understood that the various components and/or the functionality provided thereby can be incorporated into the host processor 1102 or provided by other connected devices. Accordingly, it is to be understood that more or less of the described functionality may be implemented, combined, and/or distributed (e.g., among network devices, servers, databases, and the like), according to context, system design considerations, and/or marketing factors.

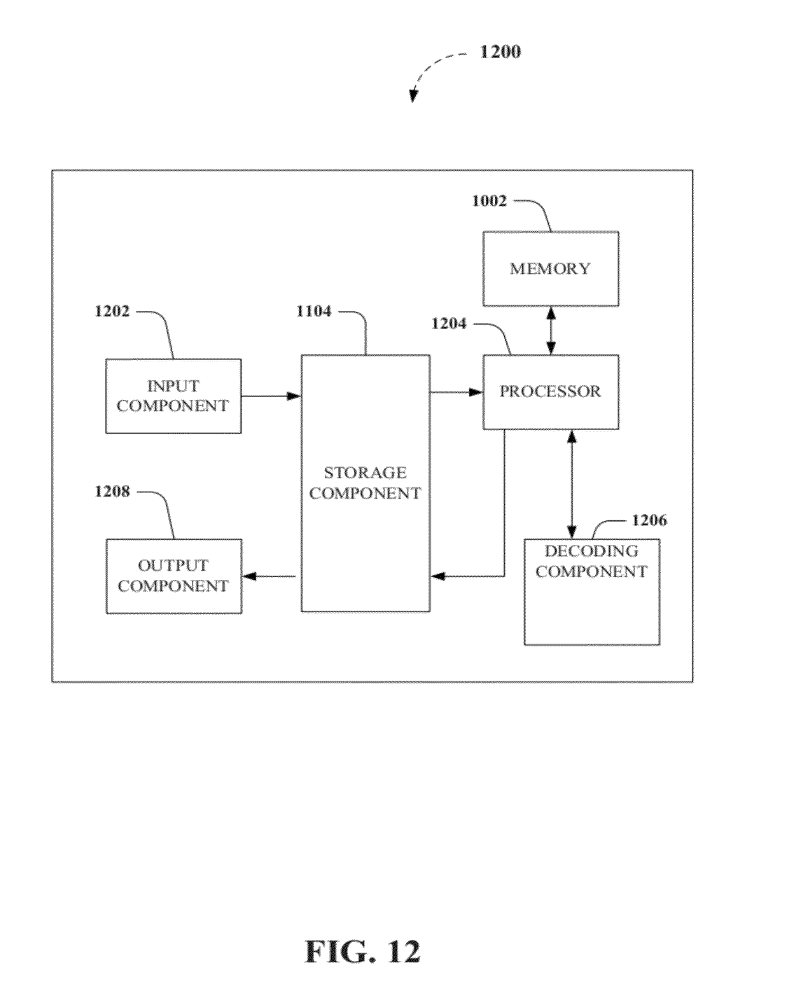

FIG. 12 illustrates an exemplary non-limiting order system or device 1200 suitable for performing various aspects of the disclosed subject matter. Order system or device 1200 can comprise an input component 1202 that can receive data or signals, and performs typical actions thereon (e.g., transmits to storage component 1104) the received data or signal. A storage component 1104 can store the received data or signal, as described above, for subsequent processing or can provide it to a decoding component 1206, or a processor (e.g., processor 1004, 1102, 1204, etc.), via a memory (e.g., memory 1002, etc.) over a suitable communications bus or otherwise, or to the output component 1208.

Processor 1204 can be a processor dedicated to analyzing information received by input component 1202 and/or generating information for transmission by an output component 1208. Processor 1204 can be a processor that controls one or more portions of order system or device 1200, and/or a processor that analyzes information received by input component 1202, generates information for transmission by output component 1208, and performs various decoding algorithms of decoding component 1206. Decoding component 1206 can include various algorithms and routines to facilitate communication according specified network protocols and coding algorithms.

While decoding component 1206 is shown external to the processor 1204 and memory 1002, it is to be understood that decoding component 1206 can include decoding code stored in storage component 1104 and subsequently retained in memory 1002 for execution by processor 1204. It can be understood that various routines performed by system or device 1200 can utilize artificial intelligence based methods in connection with performing inference and/or probabilistic determinations and/or statistical-based determinations in connection with various aspects of the disclosed subject matter.

Order system or device 1200 can additionally comprise memory 1002 (e.g., memory 1004, etc.) that is operatively coupled to processor 1204 and that stores information such as described above, parameters, information, and the like, wherein such information can be employed in connection with implementing various aspects as described herein. Memory 1002 can additionally store received data or information (e.g., such as information including one or more of dynamically determined or generated reusable unique order identification code or numeric identifier for the order, the plurality of independently specifiable order attributes, copies thereof, and so on, other information such as item information, pricing information such as current pricing information, billing and payment information, merchant information, manufacturer information, seller information, contact information, etc.), as well as software routines and instructions as described above in reference to FIGS. 10-11, for example.

It will be understood that storage component 1104 and memory 1002 and/or any combination thereof as described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1002 is intended to comprise, without being limited to, these and any other suitable types of memory, including processor registers and the like. In addition, by way of illustration and not limitation, storage component 1104 can include conventional storage media as in known in the art (e.g., hard disk drive).

It can be understood that various techniques described herein may be implemented in connection with hardware or software or, where appropriate, with a combination of both. As used herein, the terms “device,” “component,” “system” and the like are likewise intended to refer to a computer-related entity, either hardware, a combination of hardware and software, software, or software in execution. For example, a “device,” “component,” subcomponent, “system” portions thereof, and so on, may be, but is not limited to being, a process running on a processor, a processor, an object, an executable, a thread of execution, a program, and/or a computer. By way of illustration, both an application running on computer and the computer can be a component. One or more component(s) may reside within a process and/or thread of execution and a component may be localized on one computer and/or distributed between two or more computer(s).

It can be further understood that while a brief overview of exemplary systems, methodologies, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

### Exemplary Networked and Distributed Environments

One of ordinary skill in the art can appreciate that the various embodiments of disclosed and related systems, devices, and/or methodologies described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may utilize disclosed and related systems, devices, and/or methodologies as described for various embodiments of the subject disclosure.

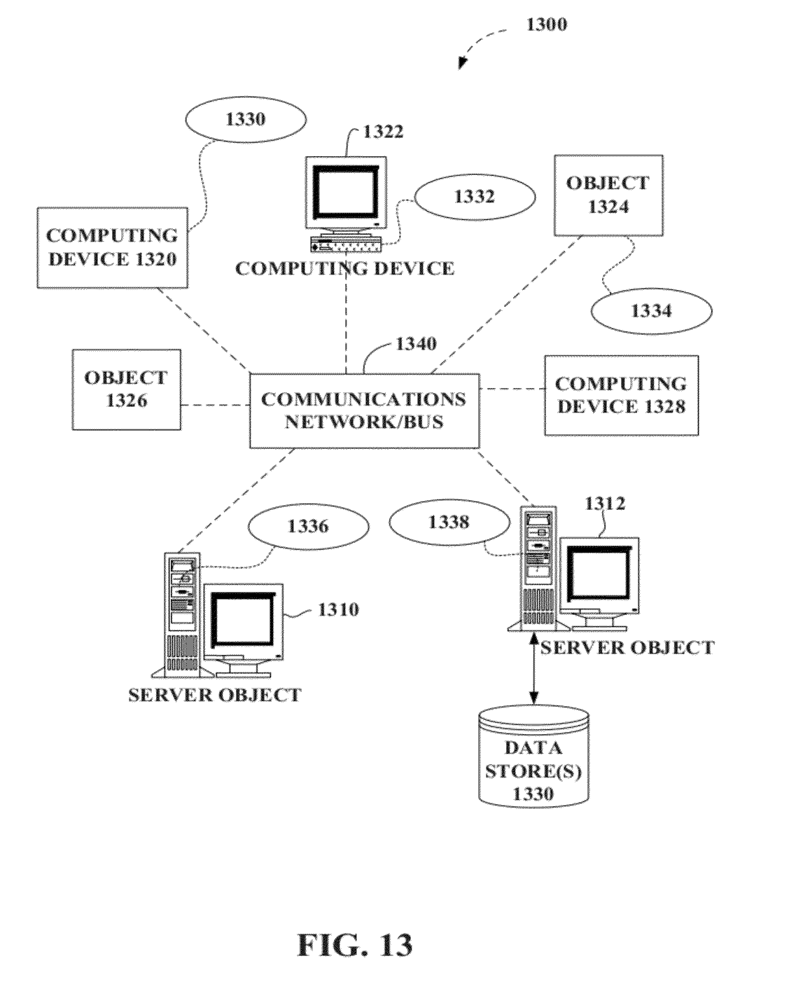

FIG. 13 provides a schematic diagram of an exemplary networked or distributed computing environment. The distributed computing environment comprises computing objects 1310, 1312, etc. and computing objects or devices 1320, 1322, 1324, 1326, 1328, etc., which may include programs, methods, data stores, programmable logic, etc., as represented by applications 1330, 1332, 1334, 1336, 1338. It can be understood that objects 1310, 1312, etc. and computing objects or devices 1320, 1322, 1324, 1326, 1328, etc. may comprise different devices, such as PDAs, audio/video devices, mobile phones, MP3 players, personal computers, laptops, etc.

Each object 1310, 1312, etc. and computing objects or devices 1320, 1322, 1324, 1326, 1328, etc. can communicate with one or more other object(s) 1310, 1312, etc. and computing object(s) or device(s) 1320, 1322, 1324, 1326, 1328, etc. by way of the communications network 1340, either directly or indirectly. Even though illustrated as a single element in FIG. 13, network 1340 may comprise other computing objects and computing devices that provide services to the system of FIG. 13, and/or may represent multiple interconnected networks, which are not shown. Each object 1310, 1312, etc. or 1320, 1322, 1324, 1326, 1328, etc. can also contain an application, such as applications 1330, 1332, 1334, 1336, 1338, that might make use of an API, or other object, software, firmware and/or hardware, suitable for communication with or implementation of disclosed and related systems, devices, methodologies, and/or functionality provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to employing disclosed and related systems, devices, and/or methodologies as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 13, as a non-limiting example, computers 1320, 1322, 1324, 1326, 1328, etc. can be thought of as clients and computers 1310, 1312, etc. can be thought of as servers where servers 1310, 1312, etc. provide data services, such as receiving data from client computers 1320, 1322, 1324, 1326, 1328, etc., storing of data, processing of data, transmitting data to client computers 1320, 1322, 1324, 1326, 1328, etc., although any computer can be considered a client, a server, or both, depending on the circumstances. Any of these computing devices may be processing data, forming metadata, synchronizing data or requesting services or tasks that may implicate disclosed and related systems, devices, and/or methodologies as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methodologies can be provided standalone, or distributed across multiple computing devices or objects.

In a network environment in which the communications network/bus 1340 is the Internet, for example, the servers 1310, 1312, etc. can be Web servers with which the clients 1320, 1322, 1324, 1326, 1328, etc. communicate via any of a number of known protocols, such as the hypertext transfer protocol (HTTP). Servers 1310, 1312, etc. may also serve as clients 1320, 1322, 1324, 1326, 1328, etc., as may be characteristic of a distributed computing environment.

### Exemplary Computing Device

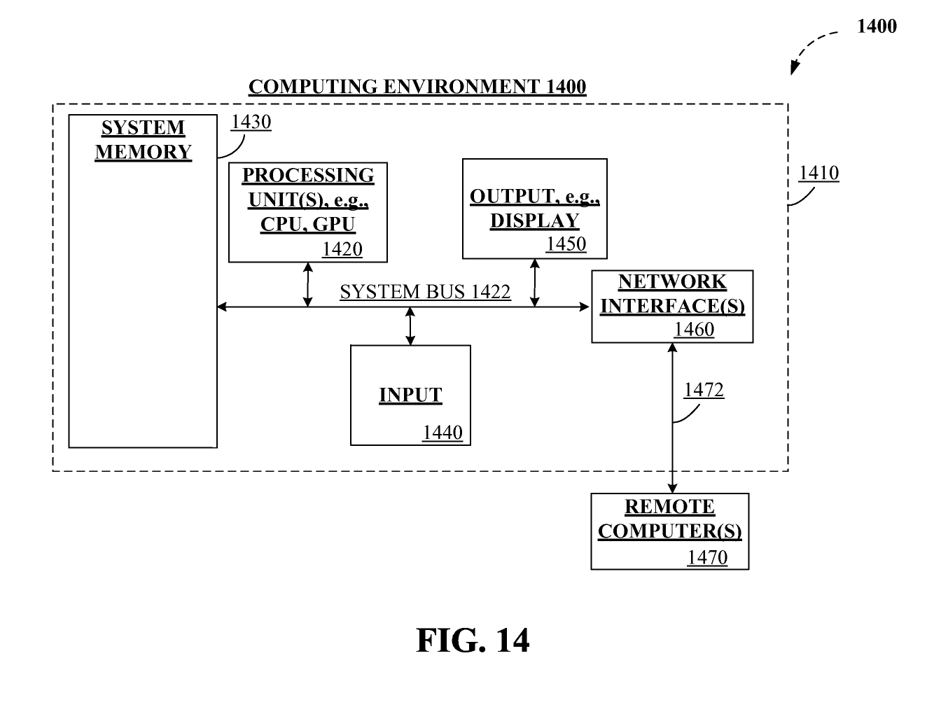

As mentioned, advantageously, the techniques described herein can be applied to any device where it is desirable to employ disclosed and related systems, devices, and/or methodologies. It should be understood, therefore, that handheld, portable and other computing devices and computing objects of all kinds are contemplated for use in connection with the various embodiments, e.g., anywhere that a device may wish to synchronize data. Accordingly, the below general purpose remote computer described below in FIG. 14 is but one example of a computing device. Additionally, disclosed and related systems, devices, and/or methodologies can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computer(s), such as client workstation(s), server(s) or other device(s). Those skilled in the art will appreciate that computer systems have a variety of configurations and protocols that can be used to communicate data, and thus, no particular configuration or protocol should be considered limiting.

FIG. 14 thus illustrates an example of a suitable computing system environment 1400 in which one or aspects of the embodiments described herein can be implemented, although as made clear above, the computing system environment 1400 is only one example of a suitable computing environment and is not intended to suggest any limitation as to scope of use or functionality. Neither should the computing environment 1400 be interpreted as having any dependency or requirement relating to any one or combination of components illustrated in the exemplary operating environment 1400.

With reference to FIG. 14, an exemplary remote device for implementing one or more embodiment(s) includes a general purpose computing device in the form of a computer 1410. Components of computer 1410 may include, but are not limited to, a processing unit 1420, a system memory 1430, and a system bus 1422 that couples various system components including the system memory to the processing unit 1420.

Computer 1410 typically includes a variety of computer readable media and can be any available media that can be accessed by computer 1410. The system memory 1430 may include computer storage media in the form of volatile and/or nonvolatile memory such as read only memory (ROM) and/or random access memory (RAM). By way of example, and not limitation, memory 1430 may also include an operating system, application programs, other program modules, and program data.

A user can enter commands and information into the computer 1410 through input devices 1440. A monitor or other type of display device is also connected to the system bus 1422 via an interface, such as output interface 1450. In addition to a monitor, computers can also include other peripheral output devices such as speakers and a printer, which may be connected through output interface 1450.

The computer 1410 may operate in a networked or distributed environment using logical connections to one or more other remote computer(s), such as remote computer 1470. The remote computer 1470 may be a personal computer, a server, a router, a network PC, a peer device or other common network node, or any other remote media consumption or transmission device, and may include any or all of the elements described above relative to the computer 1410. The logical connections depicted in FIG. 14 include a network 1472, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to employ disclosed and related systems, devices, and/or methodologies.

Also, there are multiple ways to implement the same or similar functionality, e.g., an appropriate API, tool kit, driver code, operating system, control, standalone or downloadable software object, etc. which enables applications and services to use disclosed and related systems, devices, methodologies, and/or functionality. Thus, embodiments herein are contemplated from the standpoint of an API (or other software object), as well as from a software or hardware object that implements one or more aspects of disclosed and related systems, devices, and/or methodologies as described herein. Thus, various embodiments described herein can have aspects that are wholly in hardware, partly in hardware and partly in software, as well as in software.

In addition, the word “exemplary” is used herein to mean serving as an example, instance, or illustration. For the avoidance of doubt, the subject matter disclosed herein is not limited by such examples. Moreover, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more component(s) may reside within a process and/or thread of execution and a component may be localized on one computer and/or distributed between two or more computer(s).

Systems described herein can be described with respect to interaction between several components. It can be understood that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more component(s) may be combined into a single component providing aggregate functionality or divided into several separate sub-components, and that any one or more middle component layer(s), such as a management layer, can be provided to communicatively couple to such sub-components in order to provide integrated functionality. Any components described herein may also interact with one or more other component(s) not specifically described herein but generally known by those of skill in the art.

In view of the exemplary systems described herein, methodologies that can be implemented in accordance with the described subject matter can be better appreciated with reference to the flowcharts of the various figures and vice versa. While for purposes of simplicity of explanation, the methodologies may be shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more function(s) described herein, and similarly, storage can be effected across a plurality of devices. Accordingly, the invention should not be limited to any single embodiment, but rather should be construed in breadth, spirit and scope in accordance with the appended claims.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methodologies, as shown and described herein. In any event, the structures and devices, as well as the associated methodologies described herein have many applications in customer relations management, order processing, and so on. Therefore, the disclosed subject matter should not be limited to any single embodiment described herein.

What is claimed is:

1. A method comprising:
generating a reusable unique order identification code for an order based at least in part on a plurality of independently specifiable order attributes specified by a user; and
at least one of transmitting or receiving the reusable unique order identification code to facilitate at least one transaction associated with the order.

2. The method of claim 1, further comprising:
analyzing the reusable unique order identification code and determining the plurality of independently specifiable order attributes specified by the user.

3. The method of claim 1, the generating includes dynamically determining the reusable unique order identification code for the order.

4. The method of claim 3, the dynamically determining includes computing the reusable unique order identification code from an existing reusable unique order identification code and an offset value based in part on at least one difference from an item associated with the existing reusable unique order identification code and at least one of the plurality of independently specifiable order attributes specified by the user.

5. The method of claim 1, the at least one of transmitting or receiving includes transmitting the reusable unique order identification code to the user to facilitate a future transaction associated with the order.

6. The method of claim 5, the at least one of transmitting or receiving includes receiving the reusable unique order identification code from the user to facilitate the at least one transaction.

7. The method of claim 5, the transmitting includes affixing the reusable unique order identification code to the order or information representing the order prior to delivery of the order to the user.

8. A device adapted to at least one of transmit or receive a dynamically determined reusable unique order numeric identifier determined at least in part on information comprising a plurality of independently specifiable order attributes as received from a user for an order.

9. The device of claim 8, further configured to analyze the reusable unique order numeric identifier and determining at least one of the plurality of independently specifiable order attributes received from the user.

10. The device of claim 8, further configured to at least one of transmit or receive the plurality of independently specifiable order attributes as received from the user.

11. The device of claim 8, further configured to print a label comprising the reusable unique order numeric identifier for attaching the reusable unique order numeric to the order.

12. The device of claim 8, further configured to generate the dynamically determined reusable unique order numeric identifier.

13. The device of claim 12, further configured to generate the dynamically determined reusable unique order numeric identifier based in part on an existing reusable unique order numeric identifier and an offset value, the offset value determined based in part on at least one difference from an item associated with the existing reusable unique order numeric identifier and at least one of the plurality of independently specifiable order attributes as selected by the user.

14. An order system comprising:
an identification component adapted to dynamically generate a reusable unique order numeric identifier for an order based at least in part on information comprising a plurality of independently specifiable order attributes received from a user; and
a communications component adapted to at least one of transmit or receive the reusable unique order numeric identifier determined to facilitate at least one transaction associated with the order.

15. The system of claim 14, further comprising:
an analysis component adapted to at least one of analyze the reusable unique order numeric identifier and determine at least one of the plurality of independently specifiable order attributes received from the user.

16. The system of claim 14, the communications component further configured to at least one of transmit or receive the plurality of independently specifiable order attributes received from the user.

17. The system of claim 14, further comprising:
an output component adapted to print a label comprising the reusable unique order numeric identifier for affixing the reusable unique order numeric to the order.

18. The system of claim 14, the communications component further configured to at least one of transmit or receive current pricing information associated with the reusable unique order numeric identifier.

19. The system of claim 14, the identification component further configured to dynamically generate the reusable unique order numeric identifier comprising hierarchical information associated with the plurality of independently specifiable order attributes based in part on an existing reusable unique order numeric identifier and an offset value.

20. The system of claim 19, the identification component further configured to compute the offset value based in part on at least one difference from an item associated with the existing reusable unique order numeric identifier and at least one of the plurality of independently specifiable order attributes received from the user.

21. A device adapted to receive information comprising a plurality of independently specifiable order attributes specified by a user for an order, dynamically determine a reusable unique order numeric identifier based at least in part on the plurality of independently specifiable order attributes, and transmit the reusable unique order numeric identifier to the user to facilitate subsequent transactions by the user for an identical order.

22. The device of claim 21 further configured to dynamically determine the reusable unique order numeric identifier including hierarchical information associated with the plurality of independently specifiable order attributes.

23. The device of claim 21 comprises at least one of a personal computer, a server, a mobile device, a cellular phone, a kiosk, or a network capable device.

24. An order system adapted to receive a dynamically determined reusable unique order identification code from a user to facilitate a transaction, analyze the dynamically determined reusable unique order identification code, determine at least one of a plurality of independently specifiable order attributes that form a basis for the dynamically determined reusable unique order identification code, and query the order system to determine whether the transaction can be completed.

25. The order system of claim 24 further configured to store the dynamically determined reusable unique order identification code with at least one other dynamically determined reusable unique order identification code to facilitate propagation of at least one of the dynamically determined reusable unique order identification code and the at least one other dynamically determined reusable unique order identification code with another order system.
